(19) United States
(12) Patent Application Publication
(10) Pub. No.: US 2006/0277942 A1
(43) Pub. Date: Dec. 14, 2006

(54) Method of extracting carbon dioxide and sulphur dioxide by means of anti-sublimation for the storage thereof

(76) Inventors: Denis Clodic, Paris (FR); Mourad Younes, Paris (FR)

Correspondence Address: RATNERPRESTIA, P O BOX 980, VALLEY FORGE, PA, 19482-0980, US

(21) Appl. No.: 10/547,823

(22) PCT Filed: Mar. 4, 2004
(86) PCT No.: PCT/FR04/50095

§ 371 Date: Sep. 2, 2005

(30) Foreign Application Priority Data
Mar. 4, 2003 (FR) 03/02647

(51) Int. Cl. C02F 1/22

(52) U.S. Cl. 62/532

(57) ABSTRACT

The present invention pertains to a method and a system for extracting carbon dioxide and/or sulfur dioxide from methane or fumes resulting from hydrocarbon combustion. The system according to the present invention comprises a refrigerating device with integrated cascade which cools the methane or the fumes under a pressure that ensures circulation of the methane or the fumes and at a temperature such that the carbon dioxide and/or the sulfur dioxide pass directly over from the vapor state into the solid state via an anti-sublimation process.

The present invention pertains to a method and a system that make possible the extraction or capture of sulfur dioxide or carbon dioxide and sulfur dioxide by anti-sublimation under atmospheric pressure. Sulfur dioxide is defined in terms of the present invention as sulfur dioxide (SO₂) proper, but also as chemical species of the type of SOₓ, in which x may have especially the value 3. More particularly, it pertains to a method and a system that make it possible to capture sulfur dioxide or carbon dioxide and sulfur dioxide which are present in the circulating fumes in the smokestacks of power plants generating electricity or thermal power plants or in the exhaust pipes of vehicle engines. This capture of sulfur dioxide or carbon dioxide and sulfur dioxide is carried out for the storage thereof.

The carbon dioxide or CO₂ emissions associated with combustion processes in heating systems, electric power plants or vehicle engines lead to an increase in the atmospheric CO₂ concentration, which is considered to be unacceptable in the long term. The Kyoto Protocol consists of the commitment of the parties signing the protocol to limit their emissions. Restraint and energy efficiency are not sufficient for limiting the CO₂ concentrations to acceptable levels. The capture of carbon dioxide and its sequestration are indispensable goals for the economic development and the maintenance of the atmospheric concentrations at levels that limit the change in climate.

The fumes are usually treated in power generating plants operated with coal or other fuels, including hydrocarbons, which contain variable concentrations of SO₂ ranging from 0.1% to a maximum of 3%. These treatments are carried out in specific units in agreement with the regulations in effect for limiting the discharge of SOₓ, SO₂, SO₃ and other oxides into the atmosphere, as these substances are responsible, in particular, for acid rain and, in urban areas, for irritations and lung diseases. The regulations governing the minimization of the SOₓ emissions to acceptable levels were introduced in the early 1980s in the developed countries. The value of this method and this system according to the present invention comprises the capture of SO₂ or the joint capture of CO₂ and SO₂ as well as of minor species such as unburned hydrocarbons by anti-sublimation. In fact, these minor species have, in general, concentrations below 1% and they consequently have very low partial pressures in the fumes and can be captured only below their triple point, i.e., in the solid phase.

The present invention pertains to a method of capturing sulfur dioxide or carbon dioxide and sulfur dioxide, which is applicable to any combustion system. The method according to the present invention has the feature of not causing any change in the energy efficiency of the vehicle engines or the turbines used for propulsion or electric power generation in which such combustion systems are used. The capture of CO₂ (or SO₂) according to the anti-sublimation process under atmospheric or nearly atmospheric pressure is carried out with zero increase or an extremely slight increase in energy consumption. The design of the system for an internal combustion engine for automobiles will be described as an example.

Method

The present invention pertains to a method of extracting sulfur dioxide or carbon dioxide and sulfur dioxide from the fumes originating from the combustion of hydrocarbons in the presence of atmospheric oxygen and atmospheric nitrogen in an apparatus intended especially for generating mechanical energy. The method according to the present invention comprises the step of cooling the fumes under a pressure approximately equal to the atmospheric pressure at such a temperature that the sulfur dioxide or the carbon dioxide and the sulfur dioxide pass directly over from the vapor state into the solid state via an anti-sublimation process.

The method according to the present invention is preferably such that the step of cooling the fumes under a pressure approximately equal to the atmospheric pressure at such a temperature that the sulfur dioxide or the carbon dioxide and the sulfur dioxide pass directly over from the vapor state into the solid state via an anti-sublimation process comprises, in addition, the step of extracting the water in the liquid form from the fumes under a pressure approximately equal to the atmospheric pressure.

An air or water heat exchanger is used to extract all or part of the water in the liquid form from the fumes under a pressure approximately equal to the atmospheric pressure.

The method according to the present invention preferably comprises, besides, the step of extracting all the residual quantities of water present in the fumes by using a refrigerating heat exchanger and/or a dehydrating unit.

The step preferably comprising the cooling of the fumes under a pressure approximately equal to the atmospheric pressure at such a temperature that the sulfur dioxide or the carbon dioxide and the sulfur dioxide pass directly over from the vapor state into the solid state via an anti-sublimation process comprises, besides, the step of cooling the mixture of nitrogen, sulfur dioxide or of carbon dioxide and sulfur dioxide by supplying frigories by the fractionated distillation of refrigerant fluids. This fractionated distillation is carried out at decreasing temperature levels of the mixture of refrigerant fluids according to a cycle comprising a phase of compression and successive phases of condensation and evaporation.

The step comprising the cooling of the fumes under a pressure approximately equal to the atmospheric pressure at such a temperature that the sulfur dioxide or the carbon dioxide and the sulfur dioxide pass directly over from the vapor state into the solid state via an anti-sublimation process is preferably followed by a step of melting the sulfur dioxide or the carbon dioxide and the sulfur dioxide in a closed space.

The pressure and the temperature in the closed space change up to the triple points of sulfur dioxide or of carbon dioxide and sulfur dioxide as the mixture of refrigerant fluids supplies calories for the closed space while undercooling.

The mixture of refrigerant fluids preferably ensures successively
the melting of the sulfur dioxide or of the carbon dioxide and the sulfur dioxide in the closed space, and
the anti-sublimation of the sulfur dioxide or of the carbon dioxide and the sulfur dioxide circulating in an open cycle in a space symmetrical to the preceding one.

The melting and the anti-sublimation of the sulfur dioxide or of the carbon dioxide and the sulfur dioxide are carried out alternately in one or the other of the spaces, one being closed while the other is open.

The method according to the present invention comprises, in addition, the step of storing the sulfur dioxide or the carbon dioxide and the sulfur dioxide in the liquid form in a tank, especially a removable one.

The step of storing the sulfur dioxide or the carbon dioxide and the sulfur dioxide in the liquid form in a tank, especially a removable one, comprises the following steps:
the step of drawing in the liquid sulfur dioxide or the liquid carbon dioxide and the liquid sulfur dioxide contained in the closed space,
the step of restoring the pressure in the closed space to a pressure close to the atmospheric pressure, and
the step of transferring the liquid sulfur dioxide or the liquid carbon dioxide and the liquid sulfur dioxide into the tank.

The method according to the present invention preferably also comprises the step of discharging the nitrogen into the outside air after the successive extractions of the steam, the carbon dioxide, the SO₂, and the minor species such as the unburned hydrocarbons contained in the fumes.

The method according to the present invention preferably also comprises the step of
transferring the frigories contained in the nitrogen discharged into the outside air to the fumes, and
thus contributing to the cooling of the fumes.

The method according to the present invention preferably also comprises the step of cooling the fumes to the anti-sublimation temperature of the sulfur dioxide or of the carbon dioxide and the sulfur dioxide under a pressure approximately equal to the atmospheric pressure, using the heat energy available in the fumes, at least partly without the additional supply of energy.

To utilize the heat energy available in the fumes, the method according to the present invention also comprises the following steps:
the step of heating and then evaporating the water by means of the fumes to generate steam under pressure,
the step of expanding the steam under pressure in a turbine, generating mechanical energy or electricity.
   System

The present invention also pertains to a system for extracting sulfur dioxide or carbon dioxide and sulfur dioxide from fumes originating from the combustion of hydrocarbons in the presence of atmospheric oxygen and atmospheric nitrogen in an apparatus intended especially for generating mechanical energy.

The system according to the present invention comprises cooling means for cooling the fumes under a pressure approximately equal to the atmospheric pressure at such a temperature that the sulfur dioxide or the carbon dioxide and the sulfur dioxide pass directly over from the vapor state into the solid state via an anti-sublimation process.

The means for cooling the fumes under a pressure approximately equal to the atmospheric pressure at such a temperature that the sulfur dioxide or the carbon dioxide and the sulfur dioxide pass directly over from the vapor state into the solid state via an anti-sublimation process preferably also comprises extracting means, especially exchangers, to extract the water from the fumes in the liquid form under a pressure approximately equal to the atmospheric pressure.

The extracting means for extracting all or part of the water in the liquid form from the fumes under a pressure approximately equal to the atmospheric pressure preferably comprise an air or water heat exchanger.

To extract all the residual quantities of water present in the fumes, the extracting means preferably comprise a refrigerating heat exchanger and/or a dehydrating unit.

The cooling means for cooling the fumes under a pressure approximately equal to the atmospheric pressure at such a temperature that the sulfur dioxide or the carbon dioxide and the sulfur dioxide pass directly over from the vapor state into the solid state (as well as the minor species) via an anti-sublimation process comprise, moreover, a refrigerating device with integrated cascade for cooling the mixture of nitrogen, sulfur dioxide or carbon dioxide and sulfur dioxide by supplying frigories by the fractionated distillation of a mixture of refrigerant fluids. The fractionated distillation of the mixture of refrigerant fluids is carried out at decreasing temperature levels according to a cycle comprising a phase of compression and successive phases of condensation and evaporation. The refrigerating device comprises a compressor, a partial condenser, a separating tank, evaporating condensers, fume-cooling evaporators, liquid-vapor heat exchangers, anti-sublimation evaporators and expanders.

The system according to the present invention preferably also comprises a closed space traversed by a cycle in which a mixture of refrigerant fluids circulates. The pressure and the temperature in the closed space changes up to the triple points of carbon dioxide or of sulfur dioxide and sulfur dioxide as
the mixture of refrigerant fluids supplies calories for the closed space while undercooling, and
the sulfur dioxide or the carbon dioxide and the sulfur dioxide pass over from the solid state into the liquid state.

The mixture of refrigerating fluids preferably ensures successively the melting of the sulfur dioxide or of the carbon dioxide and the sulfur dioxide in the closed space and the anti-sublimation of the sulfur dioxide or of the carbon dioxide and the sulfur dioxide circulating in an open cycle in a space symmetrical to the preceding one. The melting and the anti-sublimation of the sulfur dioxide or of the carbon dioxide and the sulfur dioxide are carried out alternately in one or the other of the spaces, one being closed and the other being open.

The system according to the present invention preferably also comprises storage means, especially a stationary and/or removable tank for storing the sulfur dioxide or the carbon dioxide and the sulfur dioxide in the liquid form.

The means of storing the sulfur dioxide or the carbon dioxide and the sulfur dioxide in the liquid form in a stationary and/or removable tank preferably also comprise suction means, especially a pneumatic pump. The suction means:
draw off the liquid sulfur dioxide or the liquid carbon dioxide and the liquid sulfur dioxide contained in the closed space,
restore the pressure in the closed space to a pressure close to the atmospheric pressure, and
transfer the liquid sulfur dioxide or the liquid carbon dioxide and the liquid sulfur dioxide into the tank.

The system according to the present invention preferably also comprises compression means and/or suction means for discharging the nitrogen into the outside air after the successive extractions of the steam, the sulfur dioxide or the carbon dioxide and the sulfur dioxide contained in the fumes.

The system according to the present invention preferably also comprises transfer means for transferring the frigories contained in the nitrogen discharged into the outside air to the fumes and thus contributing to the cooling of the fumes.

The system according to the present invention preferably also comprises means for recovering the heat energy present in the fumes for cooling the fumes, at least in part without the additional supply of energy, to the anti-sublimation temperature of the sulfur dioxide or of the carbon dioxide and the sulfur dioxide under a pressure approximately equal to the atmospheric pressure.

The means for recovering the heat energy present in the fumes preferably comprise:
heating means, especially a heat exchanger, for heating and evaporating the water by means of the fumes and for generating steam under pressure,
expansion means, especially a turbine, for expanding the steam under pressure and generating mechanical energy or electricity.
   General Description of the Method and the System According to the Present Invention

An embodiment variant of the present invention will be generally described below. The qualitative and quantitative explanations have been developed in the case of carbon dioxide. They can be extrapolated by the engineer skilled in the art to the case of sulfur dioxide or to the case of sulfur dioxide and carbon dioxide. Each time such an extrapolation must be carried out, the expression “(or SO₂)” is introduced. The exhaust gases, also called fumes, are typically composed of carbon dioxide (CO₂), steam (H₂O) and nitrogen (N₂). Components occurring in trace amounts, such as CO, NOₓ, SO₂, unburned hydrocarbons, etc., are found as well. All the trace gases present in the fumes represent contents generally below 1% to 2%, but some of them, such as SO₂ or the unburned hydrocarbons, can be captured considering the cooling of the total amount of the gas flow by the method as described.

Table 1 shows the typical molar and weight compositions of the exhaust fumes of an internal combustion engine.

TABLE 1

| | CO₂ | H₂O | N₂ |
|---|---|---|---|
| Molar composition (%) | 12.7 | 13.7 | 73.6 |
| Weight composition (%) | 19.5 | 8.6 | 71.9 |

Table 2 shows the typical molar compositions of coal-fired boiler fumes.

TABLE 2

| | CO₂ | SO₂ | H₂O | O₂ + N₂ |
|---|---|---|---|---|
| Molar composition (%) | 12.7 | 0.4 | 8.6 | 78.3 |

According to the method according to the present invention, these fumes are cooled both to recover the mechanical energy and to lower their temperature slightly below the ambient temperature. They are then cooled by a refrigerant cycle to a progressively lower temperature to make possible the anti-sublimation of the CO₂ (or SO₂) at a temperature that is around −80° C. and under a pressure that is on the order of magnitude of the atmospheric pressure.

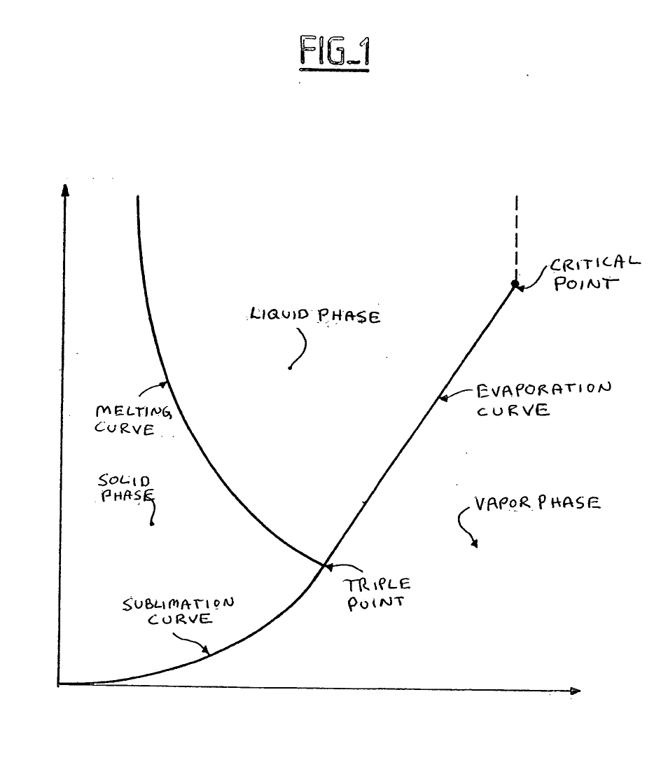

The term anti-sublimation designates here a direct gas/solid phase change that takes place when the temperature of the gas in question is below the triple point. FIG. 1 shows the diagram showing the coexistence of the solid, liquid and vapor phases in the pressure-temperature diagram. This diagram is valid for all pure substances. Below the triple point, the changes take place directly between the solid phase and the vapor phase. The change from the solid to the vapor is called sublimation. There is no commonly used term to designate the inverse change. The term anti-sublimation was used in this description to designate the direct change from the vapor phase to the solid phase.

The thermodynamic data on the fumes show that the energy available from 900° C. to 50° C. is slightly higher than 1,000 kJ/kg. The example described shows that it is possible to convert 34% to 36% of this heat energy into mechanical energy by a simple steam turbine cycle, which makes it possible to recover 30.5% to 32.5% of electricity, considering an alternator efficiency of 0.9.

The system according to the present invention is formed, on the one hand, by an energy-generating device that makes it possible to transform the heat energy into mechanical energy and/or electricity and an energy-consuming device formed by a refrigerating device designed with an integrated cascade. The temperature of the exhaust gases changes from about +900° C. to −90° C. The gases produce energy in the course of this cooling from 900° C. to about 50° C., after which they consume energy from the ambient temperature (for example, 40° C.) to −90° C. The example described shows that the available energy is significantly higher than the energy consumed and thus makes it possible to successively extract the steam and then the CO₂ (or SO₂) from the fumes, discharging into the atmosphere simply the nitrogen and the gases present in trace amounts, whose dew points are lower then −90° C.

The size of the steam turbine depends on the flow rate of the fume to be treated. For an internal combustion engine for automobiles, it is a small turbine generating electricity on the order of magnitude of 3 kW to 30 kW, depending on the output and the operation of the internal combustion engine itself. The evaporation of the water from the cycle generating mechanical energy is carried out by an exchange between the closed water cycle under pressure and the exhaust pipe. In fact, the extraction of the heat energy from the exhaust gases by a water cycle makes it possible to limit the mechanical disturbance in the exhaust gases, which would be caused, for example, by a gas turbine operated directly with the fumes. It is known that the operating parameters of diesel or gasoline engines are greatly disturbed by the changes in the exhaust pressure. If these changes in the exhaust pressure are changed significantly, they lead to a reduction of the energy efficiency of the engines. The counterflow design of the heat exchanger and the very great temperature gradient along the fume cycle makes it possible to heat and evaporate the water of the mechanical energy generation cycle. In the case of the example described, the condensation temperature equals 40° C. This temperature of 40° C. corresponds to the typical summer conditions of an air-cooled condenser.

This water is heated to a saturation temperature ranging from 310° C. to 340° C.; a saturation pressure in the boiler, which ranges from about 99 bar to 145 bar, corresponds to these temperatures. The pressure level is adjusted as a function of the operating conditions of the engine. To adjust the pressure level in the best manner possible, the flow rate of water is modified on the basis of the exhaust gas temperature measurement at the entry and/or at the outlet of the heat exchanger. The flow rate of the fumes is highly variable but is known from the knowledge of the mode of operation of the engine and the flow rate of the fuel. These data are available both from the tachometer of the engine and the electronic fuel injection control unit. These data make it possible to select the range of flow rates of the water to be circulated in the energy recovery cycle, the pressure in the water cycle being adjusted as a function of the exhaust gas temperature at the inlet and/or at the outlet of the heat exchanger.

At this boiling pressure, the liquid is consequently converted into vapor. The vapor is then itself superheated to typical temperatures of 400° C. to 550° C. as a function of the available temperature level of the exhaust gases. The vapor is then expanded in the turbine body. It is thus possible to extract the mechanical energy from the fumes. The turbine may drive an electric alternator, a flywheel or even directly the compressor of the refrigerating system. The version in which an electric alternator is driven offers more flexibility depending on the various types of use of an internal combustion engine of a vehicle.

The amounts of mechanical energy available in the case of the two operations of the cycle are evaluated on the basis of the data below.

In a first case, the condensation temperature equals 40° C. and the boiling point equals 310° C. In the second case, the condensation temperature is always equal to 40° C., but the boiling point is equal to 340° C. On the other hand, the steam is superheated at 400° C. in the first case and at 500° C. in the second case. The examples described are chosen to illustrate various operating conditions of the exhaust gas temperatures and to provide typical figures for the available outputs, expressed as a function of the flow rate M of the fumes, which itself is expressed in kg/sec. They make it possible to make generalized statements on the method according to the present invention in any pipe from which fumes containing CO₂ (or SO₂) are discharged at high temperature. The recovery of energy from the fumes has consequently caused the temperature of the fumes to change from typical values ranging from 750° C. to 900° C. to temperatures on the order of 50° C. to 80° C.

The data below show the orders of magnitude of the quantities of mechanical energy necessary to cool the fumes by a refrigerant cycle to the anti-sublimation temperature of CO₂ (or SO₂). Before arriving at the heat exchangers of the refrigerating device, the fumes are cooled from 50° C. to the ambient temperature. The heat exchange takes place in an air or water heat exchanger. Depending on the outside temperature level and depending on the levels of the components present in trace amounts, the water contained in the fume flow is partially condensed in this heat exchanger because the dew point is on the order of 50° C. for concentrations on the order of 86 g of water per kg of dry fume. However, considering the presence of trace gases in the fumes, the water may be acidic and have specific dew points higher than those of pure water. The dew points are typically between 50° C. and 100° C. in this case. The procedure to be followed for condensing the steam without taking into account the trace gases in the fumes, which raise the dew point, will be described below.

Depending on its characteristics, the condensed water may be discharged directly or stored in order to be pretreated before being discharged. Below the ambient temperature, the fumes are cooled in a cycle comprising a plurality of exchange segments. These are thus brought to a temperature below the anti-sublimation temperature of CO₂ (or SO₂) under atmospheric pressure or close to the atmospheric pressure.

The flow rate M of the fumes is changed between the air exchanger and the first cooling heat exchanger of the integrated cascade because the steam that is contained in it is condensed. If the weight concentrations equal
CO₂=19.5%, H₂=8.6% and N₂=71.9%,
respectively, the flow rate of the fumes, M, is approximately equal to the flow rate of the anhydrous medium, ignoring the concentrations of the trace gases, or
M_{N2+CO2+SO2}=0.914 M.

It is this anhydrous flow M_{N2+CO2+SO2} that continues to be cooled in the different heat exchangers of the refrigerating system before arriving at the two anti-sublimation evaporators. If the SO₂ content is as is indicated in Table 2 (0.4%), the SO₂ is still present in the gaseous phase at this temperature level considering its partial pressure, which is on the order of magnitude of 0.004 bar. Due to the fact that the surface temperature of the evaporators is below −90° C., the SO₂ is deposited there together with the CO₂. This joint capture of the SO₂ takes place up to a volume concentration of 3%, which are concentrations that are distinctly higher than the levels in the fumes with the highest SO₂ content.

The two anti-sublimation evaporators operate alternately. The fumes and the refrigerant fluid pass alternately through one or the other of the two evaporators.

During the anti-sublimation phase, the CO₂ ice or the SO₂ ice is deposited on the external walls of the heat exchanger cycle located in the anti-sublimation evaporator. In the case of the fumes containing SO₂, the SO₂ also passes directly over from the gaseous phase into the solid phase due to its partial pressure. This deposit progressively creates an obstacle to the circulation of the cold fumes. After a certain operating time on this evaporator, the fume flows in the external part of the heat exchanger and the flows of the refrigerant fluid in the interior of the heat exchanger swing into the symmetrical evaporator. The refrigerant fluid evaporates in this second evaporator in the interior of the heat exchanger and the CO₂ or the SO₂ is deposited on the external surface thereof. The first evaporator is no longer the site of evaporation during this time, and the temperature rises in the first evaporator. This temperature rise is accelerated by circulating the liquid refrigerant, before expansion, in the heat exchanger of the first evaporator. The solid CO₂ is heated from −78.5° C., which is the equilibrium temperature of the solid and gaseous phases at atmospheric pressure, to −56.5° C. and 5.2 bar, which are the pressure/temperature characteristics of the triple point, at which the three phases, namely, the solid, liquid and gaseous phases, coexist. The solid CO₂ melts, i.e., it passes over from the solid phase into the liquid phase. The SO₂ also melts beginning from −75.5° C. and at a lower pressure of 0.016 bar, i.e., it melts before CO₂ and can be preferably recovered, if necessary, during the first moments of the de-icing by an ad hoc extraction under partial vacuum.

The pressure in this heat exchanger continues to rise with the temperature rise.

Once the CO₂ (or SO₂) is entirely in the liquid phase, it is transferred by a pump into a heat-insulated tank. The pump is also able to draw in the residual gas, especially CO₂ (or SO₂). It is thus possible to bring the pressure inside the anti-sublimation evaporator from 5.2 bar to a pressure close to the atmospheric pressure in order for the fumes to be able to re-enter it.

It is now possible to carry out the following cycle and to perform the anti-sublimation of the CO₂ (or SO₂) contained in the cold fumes on the walls of the evaporator. The latter is again supplied with refrigerant fluid. The cycle thus continues alternately in the two low-temperature evaporators in parallel.

The method according to the present invention, which uses anti-sublimation, is advantageous compared to the method which comprises the passing of the gaseous phase over into the liquid CO₂ phase (or liquid SO₂ phase). In fact, to pass over directly from the gaseous phase into the liquid phase, it is necessary to increase the pressure of the fumes at least to 5.2 bar and to lower their temperature to −56.5° C. In practice, this method implies the lowering of the temperature of the fumes to 0° C. to remove the water and then to compress the mixture of nitrogen and CO₂ to at least 6 bar. The mixture of nitrogen and CO₂ is heated to 120° C. during this compression. It will again be necessary to carry out cooling from 120° C. to −56.5° C. This method implies, moreover, compression of the nitrogen to 5.2 bar to no purpose.

The refrigerating device operates according to a principle of cooling, which is known per se, the so-called cooling in integrated cascade. However, the refrigerating device according to the present invention has specific technical features which will be described below. In fact, to cool the fumes over a considerable temperature difference from ambient temperature to −90° C. by means of a simple refrigerating device comprising only a single compressor, the method according to the present invention uses a mixture of refrigerant fluids. The refrigerating device according to the present invention comprises a single compressor, two intermediate evaporating condensers and the two low-temperature anti-sublimation condensers connected in parallel, which were described above. The intermediate evaporating condensers make possible both the distillation of the refrigerant fluids and the progressive cooling of the flow of fumes.

Depending on the climatic conditions and the content of the trace components, the residual steam contained in the fumes is condensed either completely or partially in the above-described air- or water-cooled heat exchanger. If not, the water is condensed complementarily in the first heat exchanger of the refrigerating device in which the temperature is slightly higher than 0° C. and in which the residence time is sufficient to permit this condensation.

The mixtures of refrigerant fluids which make it possible to carry out a cycle may be ternary, quaternary or five-component mixtures. The mixtures described integrate the requirements of the Montreal Protocol, which bans the production and ultimately the use of refrigerant gases containing chlorine. This implies that no CFC (chlorofluorocarbon) nor H-CFC (hydrochlorofluorocarbon) is present in the components that can be used, even though several of these fluids are functionally quite interesting for being used as working fluids in an integrated cascade. The Kyoto Protocol also imposes restrictions on the gases with a high global warming potential (GWP). However, even if they are not banned at present, fluids with the lowest possible GWP are preferably used according to the present invention. The mixtures suitable for use in the integrated cascade according to the present invention to carry out the capture of CO₂ (or SO₂) from the fumes are indicated below.
Ternary mixtures

The ternary mixtures may be methane/CO₂/R-152a mixtures, or, adopting the standardized nomenclature (ISO 817) of refrigerant fluids, R-50/R-744/R-152a mixtures. It is possible to replace R-152a with butane R-600 or isobutane R-600a.
Quaternary mixtures

The quaternary mixtures may be mixtures:
of R-50/R-170/R-744/R-152a or
of R-50/R-170/R-744/R-600 or
of R-50/R-170/R-744/R-600a.
R-50 may also be replaced with R-14, but its GWP is very high (6,500 kg equivalents of CO₂).
Five-component mixtures

The five-component mixtures may be prepared by selecting 5 of these components from the list of the following eight fluids: R-740, R-50, R-14, R-170, R-744, R-600, R-600a, R-152a in adequate proportions with progressively staggered critical temperatures, these critical temperatures being presented in Table 2. The following mixtures shall be mentioned as examples:
R-50/R-14/R-170/R-744/R-600 or
R-740/R-14/R-170/R-744/R-600 or
R-740/R-14/R-170/R-744/R-600a or
R-740/R-14/R-170/R-744/R-152a or
R-740/R-50/R-170/R-744/R-152a, R-740 being argon.

Table 2 shows the principal thermochemical characteristics and the names of these fluids.

TABLE 2

| Compound | | | | |
|---|---|---|---|---|
| Chemical and | | | | Molar |
| standardized name | Chemical | Critical T | Critical P | weight |
| (ISO 817) | formula | (° C.) | (bar) | (g/mole) |
| R-740 | A | −122.43 | 48.64 | 39.94 |
| Argon | | | | |
| R-50 | CH₄ | −82.4 | 46.4 | 16.04 |
| Methane | | | | |
| T-14 | CF₄ | −45.5 | 37.4 | 88.01 |
| Tetrafluoromethane | | | | |
| R-744 | CO₂ | 31.01 | 73.77 | 44.01 |
| Carbon dioxide | | | | |
| R-170: ethane | C₂H₆ | 32.2 | 48.9 | 30.06 |
| R-152a | CHF₂—CH₃ | 113.5 | 44.9 | 66.05 |
| Difluoroethane | | | | |
| R-600a | (CH₃)₃CH | 135 | 36.47 | 58.12 |
| Isobutane or 2-methyl | | | | |
| propane | | | | |
| R-600 | CH₄H₁₀ | 152 | 37.97 | 58.12 |
| n-Butane | | | | |

The two intermediate evaporating condensers and the anti-sublimation evaporators form the three temperature stages of the integrated cascade. These three stages operate all at the same pressure because they are all connected to the suction of the compressor, but the mean temperatures of these three stages are typically on the order of magnitude of −5° C., −30° C. and −90° C., because there must be a temperature difference between the flow rate of refrigerants circulating in the other pipe of each of the heat exchangers.

The flow rates of the mixture of refrigerant fluid in the three “stages” of the integrated cascade depend on the proportion of the components in the refrigerant fluid mixtures. Consequently, there is a link between the composition and the temperature levels of the cascade.

The following data, provided as an example concerning a refrigerating device with integrated cascade, are based on the use of a refrigerant fluid mixture comprising five components, whose weight composition is as follows:

| | |
|---|---|
| R-50 | 1% |
| R-14 | 3% |
| R-170 | 19% |
| R-744 | 27% |
| R-600 | 50%. |

The proportion of the flammable and nonflammable components is such that the mixture is a nonflammable, safe mixture. The critical temperature of this mixture is 74.2° C. and its critical pressure is 50 bar.

The proportions of the components, whose critical temperature is the highest, here R-600 and R-744, are the highest in the mixture because their evaporation in the two intermediate stages makes it possible to carry out the distillation of the components with low critical temperature. The components with low critical temperature can now evaporate at a low temperature in the anti-sublimation evaporator, which is a double evaporator, operating alternately with one or the other of its parallel pipes.

The heat exchangers in the cascade are preferably counterflow heat exchangers. They make it possible to utilize the very great temperature differences between the inlets and the outlets. They also make it possible to recover heat between the liquid and the vapor at different temperatures.

The anhydrous flow of fumes, M_{N2+CO2+SO2}, after passing through the anti-sublimation evaporator, is reduced to the flow of nitrogen, M_{N2}, which accounts for 0.719 of the initial flow M. This nitrogen flow, whose temperature is −90° C., circulates in counterflow to the fume tube to participate in the cooling of the anhydrous fume flow M_{N2+CO2+SO2} and then of the total fume flow M. The nitrogen flow leaving the anti-sublimation evaporator participates in the cooling of the fumes until the temperature of the nitrogen again reaches the ambient temperature level. The pressure of the nitrogen flow M_{N2} is equal to 73% of the initial pressure of the flow M, taking into account the successive capture of the steam and the CO₂ (or SO₂) vapors. The overpressure necessary for the circulation is brought about, for example, by an air compressor, whose flow, injected into a venturi, makes it possible to extract the nitrogen flow.

Another concept consists of the compressing of the total flow at the outlet of the air cooling heat exchanger in order to make possible a slight overpressure compared to the atmospheric pressure all along the cycle in which the fumes are circulated and until it is discharged into the air.

### DETAILED DESCRIPTION OF THE METHOD AND OF THE SYSTEM ACCORDING TO THE PRESENT INVENTION

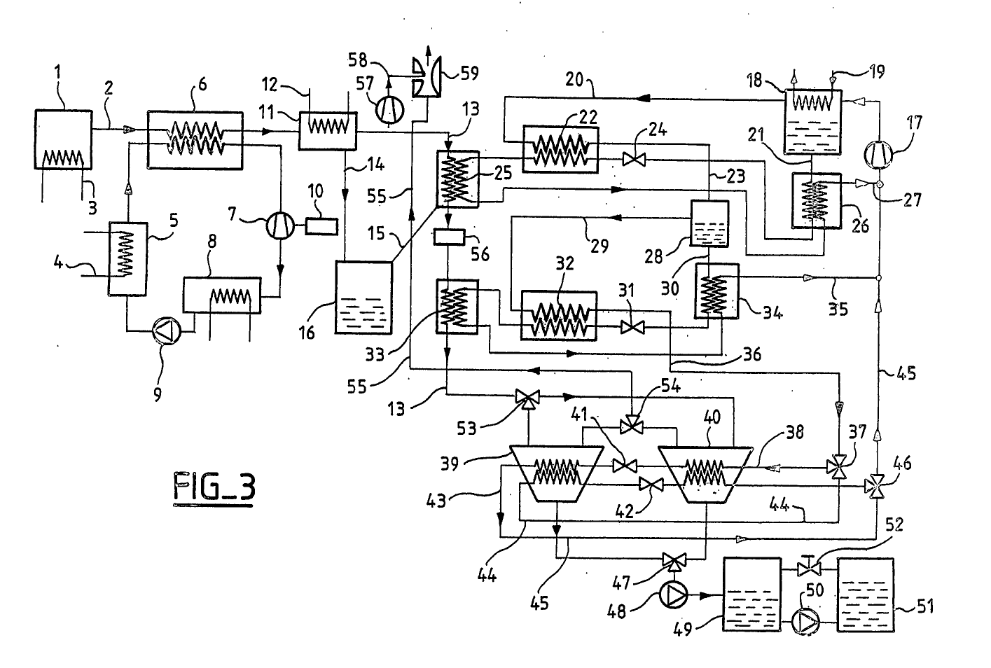

Other characteristics and advantages of the present invention will appear from the reading of the description of an embodiment variant of the present invention, which is given as an indicative and nonlimiting example and from FIG. 3, which shows a schematic view of an embodiment variant of a system which makes possible the capture of carbon dioxide by anti-sublimation. The numerical values indicated correspond to carbon dioxide, and the engineer skilled in the art can extrapolate them to the case of sulfur dioxide or to the case of sulfur dioxide and carbon dioxide. Whenever such an extrapolation is made, the mention “(or SO₂)” is inserted.

FIG. 3 will now be described. The reference numbers used are those in FIG. 3.

The table below shows the numerical reference system used. It explicitly shows the meanings of the identical technical terms with different reference numbers.

The changes in the heat content in the fumes and the chemical composition of the fumes were monitored during the circulation in the cycle in which they were cooled.

The flow M of the fumes is the sum of four flows:
M=m_{H2O}+m_{CO2}+m_{N2}+m_{traces},

in which m_{H2O} designates the flow of steam,

m_{CO2} designates the flow of carbon dioxide,

m_{N2} designates the flow of nitrogen, and

m_{traces} designates the flow of the trace gases, including SO₂ or the unburned hydrocarbons.

The fumes leave the internal combustion engine 1 (or internal combustion engine) via the pipe 2 (outlet pipe of the internal combustion engine). Their temperature is 900° C. The energy that will be released by these fumes in the heat exchanger 6 (first fume cooling heat exchanger) can be expressed as a function of the flow of the fumes, M:
Q_{ech}=M (hₛ₆−hₑ₆)

in which hₛ₆, hₑ₆ designate the enthalpies of the fumes at the outlet and the inlet of the heat exchanger 6, respectively.

The weight compositions of the fumes at the outlet of the internal combustion engine 1 equal:
CO₂: 19.5%,
H₂O: 8.6%,
N₂: 71.9%, respectively.

The trace gases, such as SO₂, were ignored in this description considering their negligible impact from the viewpoint of energy.

The energy Q_{ech} released by the fumes in the heat exchanger 6 equals approximately 1,000 kJ/kg. The temperature of the fumes at the outlet of the heat exchanger 6 is 50° C. It is possible to express the output P_{ech} released (expressed in kW) as a function of the flow of the fumes, M, expressed in kg/sec:
P_{ech}=Q_{ech}×M=1,000 kJ/kg×M kg/sec =1,000 M in kW.

The thermal energy released by the fumes in the heat exchanger 6 is converted, in a manner that is known per se, into mechanical energy, and then into electricity. The fumes release their energy to the water circulating in the heat exchanger 6. This water is successively heated in the liquid phase from 42° C. to 310° C. and then brought to a boil at the saturation pressure at 310° C., i.e., at 99 bar, or 340° C. and 145 bar, second embodiment variant of the heat exchanger 6, and this water is finally superheated to 400° C. or 500° C. in the second embodiment variant of the heat exchanger 6. The superheated steam is expanded in a turbine 7, which drives an alternator 10 in the variant being described. The expanded vapors, which are partially biphasic after this expansion, are condensed in a condenser 8, which is an air-cooled condenser. The liquid thus formed is compressed by a pump 9 to a pressure of 99 bar, 145 bar, in the second embodiment variant. The thermal energy not accounted for in the energy balances described can be optionally recovered from the cooling cycle 3 of the internal combustion engine 1. The heat exchanger 5 recovering the energy from the cooling cycle 3 of the internal combustion engine 1 comprises a recovery cycle 4 for this purpose. The connections between the recovery cycle 4 and the cooling cycle 3 of the internal combustion engine 1 are not shown. In summer, the condensation temperature is 40° C. in the air-cooled condenser 8. The condensation temperature may vary typically between 10° C. and 65° C. between the winter and the summer in the countries with the highest temperatures. The amount of the energy that can be recovered in the case of a vapor condensation temperature equaling 10° C. is larger than that recovered in the case of a condensation temperature equaling 65° C.

Tables 3 and 4 show the enthalpies of liquid water or steam for each embodiment variant:
at the inlet and at the outlet of the heat exchanger 6,
at the outlet of the turbine 7, and
at the outlet of the air-cooled condenser 8.

These four enthalpy values are representative of the energy efficiency of the energy recovery cycle. The heat exchanger 6, the turbine 7, the condenser 8 and the pump 9 are connected by pipes and form the thermal energy recovery system for recovering energy from the fumes. The thermal energy thus recovered is converted into mechanical energy.

An alternator 10 coupled with the turbine 7 makes it possible to convert the mechanical energy into electricity.

TABLE 3

| | Temperature | Pressure | H (enthalpy) | S (entropy) |
|---|---|---|---|---|
| | (° C.) | (bar) | (kJ/kg) | (kJ/kg · K) |
| Inlet of heat | 42.4 | 99 | 177.4 | |
| exchanger 6 | | | | |
| Outlet of heat | 400 | 99 | 3,098.2 | 6.2183 |
| exchanger 6 | | | | |
| Outlet of | 40 | 0.074 | 1,935.9 | 6.2183 |
| turbine 7 | | | | |
| Outlet of | 40 | 0.074 | 167.4 | |
| condenser 8 | | | | |

TABLE 4

| | Temperature | Pressure | H (enthalpy) | S (entropy) |
|---|---|---|---|---|
| Locations | (° C.) | (bar) | (kJ/kg) | (kJ/kg · K) |
| Inlet of heat | 43.5 | 145 | 182 | |
| exchanger 6 | | | | |
| Outlet of heat | 500 | 145 | 3,314.8 | 6.3659 |
| exchanger 6 | | | | |
| Outlet of | 40 | 0.074 | 1,982.1 | 6.3659 |
| turbine 7 | | | | |
| Outlet of | 40 | 0.074 | 167.4 | |
| condenser 8 | | | | |

The fumes circulate in the heat exchanger 6 in counterflow to the water flow. The temperature of the fumes varies from 900° C. to 50° C., whereas the temperature of the water varies from 40° C. to 400° C. in the first variant and up to 500° C. in the second variant. In the case of the first variant, the evaporation takes place at 310° C., under a pressure of 99 bar. In the case of the second variant, the evaporation takes place at 340° C., under a pressure of 145 bar. The heat exchanger 6 is consequently a water heater and a boiler at the same time.

In the case of the first variant, in which the temperature at the outlet of the heat exchanger 6 equals 400° C., the pressure at the inlet of the heat exchanger 6 equals 99 bar, and the condensation temperature equals 40° C., Table 3 makes it possible to determine the mechanical energy, expressed by the unit mass flow of water in the heat exchanger 6 cycle. For a mechanical efficiency of the turbine 7 equaling 0.85, the mechanical energy equals
(3,098.2−1,935.9)×0.85=988 kJ/kg.

In case of the second variant, when the temperature at the outlet of the heat exchanger 6 equals 500° C., the pressure at the inlet of the heat exchanger 6 equals 145 bar and the condensation temperature equals 40° C., Table 4 makes it possible to determine the mechanical energy, expressed by the unit mass flow of the water in the heat exchanger 6 cycle. For a mechanical efficiency of the turbine 7 equaling 0.85, the mechanical energy equals
(3,314.8−1,982.1)×0.85=1,132.8 kJ/kg.

In the case of the first variant, the energy supplied by the fume cycle to the heat exchanger 6 equals
Q_{ech}=3,098.2−177.4=2,920.8 kJ/kg.

In the case of the second variant, the energy supplied by the fume cycle to the heat exchanger 6 equals
Q_{ech}=3,314.8−182=3,132.8 kJ/kg.

It was pointed out above that the thermal output P_{ech} released by the fumes in the heat exchanger 6 equals
P_{ech}=1,000 M, expressed in kW, as a function of the fume flow.

The mechanical output extracted is expressed as a function of the fume flow on the basis of the yield of the turbine cycle:

The mechanical energy extracted, related to this flow M, will express the yield of the turbine cycle as a function of the fume flow:
In case 1: P_{mech}=(988/2,920.8)×1,000×M=338.6 M in kW,
in case 2: P_{mech}=(1,132.8/3,132.8)×1,000×M=361.6 M in kW.

In the case of the first and second embodiments, the alternator 10 has an efficiency of 0.9. The electric power P_{elec} obtained thanks to the cycle recovering thermal energy from the fumes is:
P_{elec}=304.5 M in kW in the case of the first embodiment variant and
P_{elec}=325.4 M in kW in the case of the second embodiment variant.

It is consequently possible to recover between 30.5% and 32.5% of electricity from the fumes when their temperature is above 400° C.

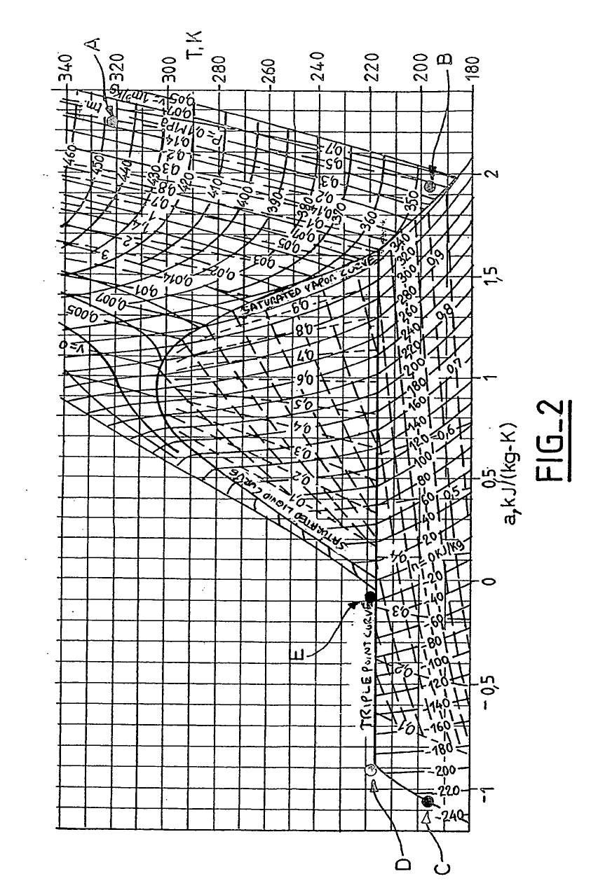

The successive fume cooling phases in the different heat exchangers will now be described. Cooling is a pure cooling for nitrogen, cooling and condensation for water, and cooling and anti-sublimation for CO₂ (or SO₂). To understand where the liquid water and the solid and then liquid CO₂ (or SO₂) are extracted, it is necessary to monitor the changes in the mass flows of these three components and the changes in energy along the fume cooling cycle, i.e., along the pipe 13. The changes in energy are expressed for each of the components in kJ/kg and are additive magnitudes, as are the weight fractions. The enthalpies of nitrogen are shown in Table 6, the enthalpies of CO₂ (or SO₂) are shown in Table 5, and FIG. 2 shows, in a manner known per se, a temperature-vs.-entropy diagram for CO₂ (or SO₂). In this diagram,
the temperatures are expressed in K,
the entropies are expressed in kJ/kg·K.

Point A is a point representative of CO₂ at the inlet of the first (No. 1) cooling evaporator 25. The pressure is 1 bar, the temperature is 50° C. (323 K), and the enthalpy of CO₂ (or SO₂) is 450.8 kJ (cf. Table 5).

Point B is a point representative of the state of CO₂ (or SO₂) at the outlet of the heat exchanger 11, the temperature is 40° C., and the enthalpy is shown in Table 5.

Point C is a point representative of CO₂ (or SO₂) at the inlet of the anti-sublimation evaporator (No. 1) 39, before the gas/solid phase change. The pressure is 0.85 bar and the temperature is −72° C. (201 K), and the enthalpy is 349 kJ/kg (cf. Table 5).

Point D is a point representative of CO₂ (or SO₂) on the complete solidification curve of CO₂ (or SO₂) at −80° C. The solidification takes place on the wall of the tube of the anti-sublimation evaporator (No. 1) 39. The complete gas/solid phase change has required a cooling energy of 568 kJ/kg.

Point E is a point representative of CO₂ (or SO₂) during the de-icing operation by the sublimation of solid CO₂ (or solid SO₂) in the space of the anti-sublimation evaporator (No. 1) 40. This operation leads to a pressure increase due to partial sublimation of the solid CO₂ (or solid SO₂). which increases the vapor pressure to 5.2 bar.

Point F is a point representative of CO₂ (or solid SO₂[)], at the end of the melting of CO₂ (or solid SO₂) under a constant pressure of 5.2 bar. The CO₂ (or solid SO₂) is consequently liquid in its entirety at point F.

TABLE 5

| | Pressure | Temperature (° C.) | Enthalpy |
|---|---|---|---|
| Points | (bar) | (K) | (kJ/kg) |
| A | 1 | 50 (323 K) | 450.8 |
| B | 1 | 40 (313 K) | 442 |
| C | 0.85 | −72 (201 K) | 349 |
| D | 0.85 | −80 (193 K) | −228 |
| E | 5.2 | −56.5 (216.6 K) | −190 |
| F | 5.2 | −56.5 (216.6 K) | 0 |

The energy balances using the values in Table 5 will be described below.

The description of the changes in the fume flow at the inlet of the fume cooling heat exchanger 11 will be continued now and the mechanism of capture of steam as well as the energy consumption associated therewith will be explicitly explained.

Table 6 shows the changes in temperatures, enthalpies and weight fractions at the inlets and outlets of the heat exchangers and the pipe sections connecting same. The changes in flow as a function of the successive captures of steam and then CO₂ (or SO₂) will be described as well, indicating the amount of energy extracted in each heat exchanger. The fume pipe 13 and the nitrogen vent pipe 55 are arranged in close contact and are heat insulated from the outside. The sections of the pipes 13 and 55 located between the elements 11, 25, 33, 39 and 40 form the successive heat exchangers.

TABLE 6?

| | | | | | | Δ(hs-he) |
|---|---|---|---|---|---|---|
| | | | | | | J/kg |
| | | | | | | Energy of |
| | | | | Weight | Weight | the |
| Heat | Inlets | T | Fume | fraction | fraction | different |
| exchangers | Outlets | (° C.) | flow | of CO₂ | of H₂O | exchanges |
| Heat | I 11 | 50 | M | 0.195 | 0.086 | 109 |
| exchanger | O 11 | 40 | 0.964 N | | 0.05 | |
| 11 | | | | | | |
| Pipe 55 | 25 | 1 | 0.719 M | 0.195 | | 26.3 |
| between 25 | 11 | 40 | | | | |
| and 11 | | | | | | |
| Heat | I 25 | 36.5 | 0.956 M | 0.195 | 0.042 | 138 |
| exchanger | O 25 | 1 | 0.914 M | | 0 | |
| 25 | | | | | | |
| Pipe 55 | 33 | −20 | 0.719 M | 0.195 | | 14 |
| between 33 | 25 | 1 | | | | |
| and 25 | | | | | | |
| Heat | I 33 | −14 | 0.914 M | 0.195 | 0 | 5.4 |
| exchanger | O 33 | −20 | 0.914 M | | 0 | |
| 33 | | | | | | |
| Pipe 55 | 39 or | −90 | 0.719 M | | | 47 |
| between 39 | 40 | −20 | | | | |
| or 40 and | 33 | | | | | |
| 33 | | | | | | |
| Evaporator | I 39 | −72 | 0.914 M | 0.195 | 0 | 125.9 |
| 39 or 40 | (40) | −80 | 0.719 M | 0 | 0 | |
| | CO₂ | −90 | 0.719 M | 0 | 0 | |
| | ice | | | | | |
| | O 39 | | | | | |
| | (40) | | | | | |

The cooling of the fumes in the heat exchanger 11 from 50° C. to 40° C. with partial condensation of the water requires an output of 109 M (kW); the water begins to condense in this fume cooling heat exchanger 11 in the example being discussed. For other temperature conditions or due to the presence of trace compounds, which modify the dew point of the water, the condensation of water may begin in the heat exchanger 6. In fact, the dew point of water is about 50° C. if the weight concentration of water in the fumes is 8.6%. The flow of the fumes at the outlet of the heat exchanger 11 is equal to 0.964 M. The weight fraction of water has changed from 8.6% to 5%. The heat exchanger 11 is designed such as to permit the removal of the condensates of water via the pipe 14. Pipe 14 connects the heat exchanger 11 with the water collecting tank 16.

The fumes in the pipe 13 are cooled by the pipe 55 connecting the heat exchanger 11 to the inlet of the heat exchanger 25. These pipe sections are, moreover, heat insulated from the outside.

Let us state precisely the mode of exchange between the two pipes 13 and 55: They are in thermally effective contact for each connection section that forms the pipe 13 between the heat exchangers 11, 25, 33 and 39 or 40. These three sections form true heat exchangers in which the cold of the nitrogen flow in the pipe 55 cools the fume flow circulating in counterflow in the pipe 13. Table 6 shows the change in enthalpy of the nitrogen flow in the pipe 55 for each of the three sections between the heat exchangers 39 or 40 and the heat exchanger 33 and then between the heat exchanger 33 and the heat exchanger 25 and, finally, between the heat exchanger 25 and the heat exchanger 11. The change in enthalpy of the nitrogen flow, equaling 0.719 M (kg/sec), is transmitted with an exchange efficiency of 90% to the flow of the fumes circulating in the pipe 13 in each of the above-mentioned three heat exchanger sections. The energy released by the nitrogen flow between the heat exchangers 11 and 25 is 26.3 M (kW). It is used both to condense part of the steam, which is reduced to 4.2%, and to cool the fume flow up 36.5° C. at the inlet of the heat exchanger 25.

At the outlet of the heat exchanger 25, the flow of the fumes is at a temperature of 1° C., which requires a refrigerating output of 138 M (kW) in the heat exchanger 25 to make possible such a lowering of the fume temperature and the condensation of the remaining steam.

The temperature of the fumes is adjusted to 1° C. to avoid the formation of ice from the water contained in the fumes. The section and the design of the first (No. 1) cooling evaporator 25 make it possible to ensure the intense dehumidification of the fume flow. Less than 0.05 wt. % of water will typically remain in the fumes at the outlet of the first (No. 1) cooling evaporator 25.

The fume pipe 13 communicates with the internal chamber of the first (No. 1) cooling evaporator 25. The water extracted from the fumes during their passage through the first (No. 1) cooling evaporator 25 is recovered in the internal chamber. It is then transferred into the water collecting tank 16 via the water drainage pipe 15 of the first (No. 1) cooling evaporator 25. The fumes leaving the first (No. 1) cooling evaporator 25 pass through a dehydrating unit 56, which ensures complete drying of the fumes. The anhydrous mass flow of the fumes, designated by M_{N2+CO2+SO2}, equals 0.914 of the flow M leaving the internal combustion engine 1. In fact, 8.6% of the mass flow has been captured in the form of liquid water in the fume cooling heat exchanger 11, in the heat exchanger formed by the sections of the pipes 13 and 55, which are in contact, in the first (No. 1) cooling evaporator 25 and in the dehydrating unit 56.

The nitrogen flow circulating in the pipe 55 yields a refrigerating output of 14 M (kW) in the section of the pipe 13 which connects the heat exchangers 25 and 33 and cools the residual fume flow M_{N2+CO2+SO2} of nitrogen and CO₂ (or SO₂) to a temperature of −14° C. at the inlet of the heat exchanger 33.

A refrigerating output of 5.4 M is supplied in the second (No. 2) cooling evaporator 33, and the residual flow M_{N2+CO2+SO2} of nitrogen and CO₂ (or SO₂) is cooled to a temperature of −20° C.

Considering the cooling between the pipes 13 and 55, the residual flow M_{N2+CO2+SO2} enters one of the two anti-sublimation evaporators (No. 1) 39 or (No. 2) 40 with a temperature on the order of −72° C. because the pipe 55 has supplied a refrigerating output of 47 M (kW).

The form and the design of the two anti-sublimation evaporators (No. 1) 39 or (No. 2) 40 make possible a long residence time for the gases. The residual fume flow M_{N2+CO2+SO2} is cooled to the anti-sublimation of CO₂ (or SO₂), which requires a refrigerating output of 125.9 M (in kW). The CO₂ (or SO₂) is thus captured by anti-sublimation at a temperature on the order of −80° C. under a pressure of 0.85 bar (absolute) or −78.6° C. under a pressure of 1 bar in the anti-sublimation evaporator 39 or 40, whereas the residual nitrogen flow, designated by M_{N2}, is cooled to −90° C. and then discharged into the atmosphere via the pipe 55, which performs a counterflow exchange with the pipe 13.

The changes in the energy of CO₂ (or SO₂) in the anti-sublimation evaporator (No. 1) 39, which it enters with a temperature of about −72° C. and an enthalpy of 349 kJ/kg (point C in Table 5 and FIG. 2), are described in detail. The complete vapor-solid phase change (anti-sublimation) takes place on the tube of the anti-sublimation evaporator (No. 1) 39, the CO₂ (or SO₂) changes toward point D (Table 5 and FIG. 2), and its enthalpy is −228 kJ/kg.

The refrigerating output, expressed in kW, as a function of the fume flow, is
(349−(−228))×0.195 M=112.5 M.

Before expansion in the expander (No. 1) 41, the refrigerant fluid passes through the anti-sublimation evaporator (No. 2) 40, which is in the de-icing phase. The refrigerant fluid thus recovers the energy of melting of the CO₂. The recoverable energy corresponds, in the diagram in FIG. 2, to the change from point D (solid CO₂ at 0.85 bar) (or SO₂) to point F (liquid CO₂ at 5.2 bar) (or SO₂). The gross change in enthalpy is 228 kJ/kg. In case of the embodiment variant described, the efficiency of transfer of the heat exchangers is 90%. Consequently, the recovered energy equals 205 kJ/kg. The refrigerating output recovered as a function of the total fume flow M is 40 M, expressed in kW:
205×0.195 M=40 M.

Taking into account the energy recovery from the de-icing of CO₂ (or SO₂) by the liquid refrigerant fluid, the anti-sublimation of CO₂ (or SO₂) at an evaporation temperature of −90° C. (there must be a difference of about 10° C. between the refrigerant fluid and the CO₂ vapor or solid CO₂ to convert CO₂ into ice) (or SO₂) requires only a refrigerating output of (112.5−40) M=72.5 M (expressed in kW).

It was seen that the electric powers (expressed in kW) that can be recovered in the case of the above-described two embodiment variants equal 304.5 M and 325.4 M, respectively. They are higher than the electric power needed for compression that the compressor must provide to generate the refrigerating output. In fact, expressed in kW as a function of the fume flow M, the electric power needed for compression is on the order of magnitude of 187 M.

This energy balance can be validated by performing a theoretical estimation of the electric power needed for compression which the compressor must provide to generate the refrigerating output. To carry out this estimation, it is necessary at first to recall what is meant by the coefficient of performance of a refrigerating machine. The coefficient of performance is the ratio of the refrigerating output P_{frig} to the electric power provided by the compressor motor, P_{elec.}_{_{—}}_{comp.}:
COP=P_{frig}/P_{elec.}_{_{—}}_{comp.}

Considering the fact that the refrigerating outputs will be exchanged at different temperature levels: −5° C., −30° C., −90° C., it is absolutely necessary to use a typical law describing the change in the coefficient of performance as a function of the temperature.

The simplest way of expressing this law is to express it as a function of Carnot's coefficient of performance. Carnot's coefficient of performance represents the ideal performance of refrigerating machines and is calculated simply as a function of the condensation temperatures

(T_{cond}) and evaporation temperatures (Tₑᵥₐₚ) according to the formula:
COP_{Carnot}=Tₑᵥₐₚ/(T_{cond}−Tₑᵥₐₚ),
the temperatures being expressed in K.

A law based on the analysis of real machines can be expressed by:
COP=(2.15×10⁻³ T+0.025)COP_{carnot}.

Table 7 below shows the COP values as a function of the evaporation temperatures.

TABLE 7

| | | (2.15 × 10⁻³ | | |
|---|---|---|---|---|
| T (° C.) | T (K) | T + 0.025) | COP_{Carnot} | COP |
| −90 | 183 | 0.42 | 1.4 | 0.59 |
| −60 | 213 | 0.48 | 2.13 | 1.02 |
| −40 | 233 | 0.525 | 2.91 | 1.53 |
| −30 | 243 | 0.547 | 3.47 | 1.9 |
| −5 | 268 | 0.6 | 5.95 | 3.57 |

This table makes it possible to calculate the electric power consumed by the compression as a function of the temperature level at which the refrigerating output is supplied. The coefficients of performance make it possible to calculate the output consumed by the compressor to supply the refrigerating output for different heat exchangers.

The refrigerating output supplied for the heat exchanger 25 to cool the fumes to 0° C. is supplied at −5° C. As the refrigerating output to be supplied equals 138 M (Table 6), and as the coefficient of performance is 3.57 (Table 7), the electric power consumed by the compressor equals 138 M/3.57=38.6 M in kW.

The refrigerating output supplied for the second fume cooling evaporator 33 is supplied at −30° C. As the refrigerating output to be supplied equals 5.4 M (Table 6) and as the coefficient of performance is 1.9 (Table 7), the electric power consumed by the compressor equals 5.4/1.9=2.8 M in kW.

The refrigerating output supplied for the anti-sublimation evaporators (No. 1) 39 or (No. 2) 40 is supplied at −90° C. As the refrigerating output is (125.9 M−40 M)=85.9 M and as the coefficient of performance is 0.59 (Table 7), the electric power consumed by the compressor equals 85.9 M/0.59=145.6 M in kW.

The refrigerating output necessary for cooling the nitrogen from 50° C. to −90° C. was taken into account in the calculations of each heat exchanger.

The total electric power needed for compression (P_{comp}) is consequently to be supplied only for the evaporators 25, 33 and 39 or 40 and it consequently equals

P_{Comp}=38.6+2.8+145.6=187 M in kW, just as that mentioned above.

The electric power consumed by the refrigerating compressor as a function of the fume flow M is consequently 187 M in kW. This power is to be compared to the electric power recovered from the fume flow, which ranges from 304.5 M to 325.4 M. The electric power of the compressor consequently accounts for about 60% of the electricity that can be recovered by the above-described recovery cycle with steam.

In reference again to FIG. 3, the operation of the refrigerating device operating with an integrated cascade will now be specifically described. The refrigerating compressor 17 draws the vapor phase mass flow from one of the multicomponent refrigerant mixtures as defined above. More particularly, in the case of the embodiment variant which will be described below, the mixture is composed of five components, whose weight percentages are as follows:

| | |
|---|---|
| R-50 | (1%) |
| R-14 | (3%) |
| R-170 | (19%) |
| R-744 | (27%) |
| R-600 | (50%). |

The suction pressure is 1.7 bar. The condensation pressure is 22 bar if the condensate is discharged at a temperature of 40° C. The partial refrigerating condenser 18 is cooled by a cooling cycle 19, the cooling cycle of the partial refrigerating condenser. Water or air circulates in the cooling cycle 19.

The partial refrigerating condenser 18 is a separator for separating the liquid and gaseous phases of the total incoming refrigerant flow, hereinafter designated by M_{f}. The gas-phase flow, hereinafter designated by Mₜₑₜₑ₁, leaves at the top, at the head, of the partial refrigerating condenser 18 via the pipe 20. The liquid flow, hereinafter designated by M_{pied1}, leaves at the bottom, at the foot, via the pipe 21. The liquids are drained off at the bottom from the partial refrigerating condenser 18 under the action of gravity.

The liquid flow (M_{pied1}) is undercooled in the liquid-vapor heat exchanger (No. 1) 26. This flow (M_{pied1}) approximately equals 50% of the total refrigerant flow (M_{f}). The liquid flow (M_{pied1}) is rich in the heaviest components, i.e., R-600 and R-744, and expands in the expander 24 to the evaporation pressure of 1.7 bar. The expanded liquid flow (M_{pied1}) successively evaporates in the first (No. 1) evaporating condenser 22 and then in the first (No. 1) fume cooling evaporator 25, in which the evaporation is accomplished. The fluid flow (M_{pied1}), which is thus evaporated in its entirety, will release its cold in the liquid-vapor heat exchanger (No. 1) and then re-enters the suction collecting tank of the compressor 17 via the pipe 27.

The gas flow (Mₜₑₜₑ₁) leaving at the head of the partial condenser 18 accounts for the other 50% of the total refrigerant flow (M_{f}). The gas flow (Mₜₑₜₑ₁) will condense partially in the first (No. 1) evaporating condenser 22. This flow (Mₜₑₜₑ₁), which became biphasic (liquid-vapor) at the outlet of the first (No. 1) evaporating condenser 22, will separate into an independent liquid phase and an independent vapor phase in the separating tank 28. The vapor phase flow (Mₜₑₜₑ₂) leaves at the head of the separating tank 28 via the pipe 29. The liquid flow (M_{pied2}) leaves at the foot of the separating tank 28. The gas flow (Mₜₑₜₑ₁) leaving at the head of the partial condenser 18 has thus been separated into two flows: A gas flow (Mₜₑₜₑ₂) accounts for 40% of the incoming flow (Mₜₑₜₑ₁) and a liquid flow (M_{pied2}) accounting for 60% of the incoming flow (Mₜₑₜₑ₁). The gas-phase flow (Mₜₑₜₑ₂) leaving the separating tank 28 via the pipe 29 will be condensed in its entirety in the second (No. 2) evaporating condenser 32. The entirely liquid flow (Mₜₑₜₑ₂) evaporates alternately in the anti-sublimation evaporators (No. 1) or (No. 2) 39 or 40.

The condensation of the gas-phase flow (Mₜₑₜₑ₂) leaving the separating tank 28 in the second (No. 2) evaporating condenser 32 was carried out by the partial evaporation of the liquid flow (M_{pied2}) leaving at the foot of the separating tank 28 and after this liquid (M_{pied2}) is expanded in the expander 31. The liquid flow (M_{pied2}) evaporates in the fume cooling evaporator 33. The completely evaporated liquid flow (M_{pied2}) releases its cold in the second (No. 2) liquid-vapor heat exchanger 34 and then re-enters the suction collecting tank of the compressor 17 via the pipe 35.

The liquid flow (Mₜₑₜₑ₂) passes through the first (No. 1) three-way valve 37. This valve is opened at the pipe 38 and consequently closed at the pipe 44. The liquid flow (Mₜₑₜₑ₂) undercools in the second (No. 2) anti-sublimation evaporator 40, which is used now as an undercooling heat exchanger during its CO₂ de-icing phase. The undercooled liquid flow (Mₜₑₜₑ₂) is then expanded in the first (No. 1) expander 41. It will then evaporate in the first (No. 1) anti-sublimation evaporator 39.

The flow of refrigerant vapors (Mₜₑₜₑ₂) leaving the first (No. 1) anti-sublimation evaporator 39 passes through the second (No. 2) three-way valve 46 and returns into the refrigerating compressor 17 via the gas return pipe 45. This flow (Mₜₑₜₑ₂) accounts for about 20% of the total refrigerant flow (M_{f}) drawn in by the refrigerating compressor 17.

When the operation of the first (No. 1) anti-sublimation evaporator 39 is alternated with that of the second (No. 2) anti-sublimation evaporator 40, the first (No. 1) three-way valve 37 changes over, via the pipe 44, the liquid refrigerant fluid circulation toward the first (No. 1) anti-sublimation evaporator 39, where it is undercooled. The refrigerant fluid then expands in the expander (No. 2) 42. It then evaporates in the second (No. 2) anti-sublimation evaporator 40 and then returns into the refrigerating compressor 17 via the second (No. 2) three-way valve 46 and the pipe 45.

The circulation of the refrigerant fluid in the two anti-sublimation evaporators 39 and 40 will now be described. These anti-sublimation evaporators operate alternately. When one of them is effectively an evaporator, the other is an undercooling heat exchanger and vice versa. If the evaporation takes place in the first (No. 1) anti-sublimation evaporator 39, the first (No. 1) three-way valve 37 is open, and the refrigerant mixture can circulate in the pipe 38, but it cannot circulate in the pipe 44.

After expansion in the expander (No. 1) 41, the liquid refrigerant mixture (Mₜₑₜₑ₂) evaporates in the first (No. 1) anti-sublimation evaporator 39 at a temperature beginning approximately at −100° C. and up to a temperature on the order of −70° C. at the outlet.

In the case of the figure being investigated, the fumes originating from the second (No. 2) fume cooling evaporator 33 pass through the fourths (No. 4) three-way valve 53 to enter the first (No. 1) anti-sublimation evaporator 39. In the case of the figure, the fumes do not enter the second (No. 2) anti-sublimation evaporator 40.

These fumes cool from their entry temperature, which is about −72° C., to the anti-sublimation temperature of CO₂, which equals −78.6° C., or −80° C., depending on whether the pressure in the first (No. 1) anti-sublimation evaporator 39 is 1 bar (absolute) or 0.85 bar (absolute). Once this temperature has been reached, the CO₂ forms ice, in the interior of the first (No. 1) anti-sublimation evaporator 39, on the external wall of the pipe in which the refrigerant mixture is circulating.

Before entering the first (No. 1) anti-sublimation evaporator 39, the refrigerant liquid enters the second (No. 2) anti-sublimation evaporator 40, which operates as an underooling heat exchanger, at a temperature around −45° C. The refrigerant fluid undercools from −45° C. to −78° C. at the beginning of the CO₂ (or SO₂) de-icing cycle and only from −45° C. to −55° C. at the end of the CO₂ (or SO₂) de-icing cycle. The liquid CO₂ accumulates during the de-icing in the lower part of the second (No. 2) anti-sublimation evaporator 40. Before swinging over the operation of the second (No. 2) anti-sublimation evaporator 40 into evaporation mode and at the end of the liquefaction of CO₂ (or SO₂), the third (No. 3) three-way valve 47 is opened. It is thus possible to draw in liquid CO₂ (or liquid SO₂) by means of the pump 48, the liquid CO₂ (or liquid SO₂) suction pump. The pump 48 is, for example, an electric pneumatic pump permitting both liquid and gas to be pumped. Pump 48 transfers the liquid CO₂ (or liquid SO₂) into the storage tank 49 and then draws in the vapors of CO₂ (or SO₂), which are mixed with nitrogen, to restore the gaseous environment of the second (No. 2) anti-sublimation evaporator 40 to the operating pressure or 0.85 bar (absolute) or 1 bar (absolute), depending on the technical option selected for the fume circulation. For practical reasons, particularly for vehicles, a removable tank 51 is connected with the storage tank 49. The pump 50, the filling pump of the removable tank, makes it possible to fill the removable tank 51 from the storage tank 49. The valve 52 makes it possible to balance the pressures between the two tanks 49 and 51 if necessary. The removable tank 51 makes possible the transport of the captured CO₂ (or captured SO₂). A new evacuated removable tank replaces the one that has been filled.

The circulation of the nitrogen leaving the first (No. 1) anti-sublimation evaporator 39 will now be described. The nitrogen vapors pass through the fifth (No. 5) three-way valve 54 and then re-enter the nitrogen vent pipe 55. The fifth (No. 5) three-way valve 54 establishes the communication, as the case may be, between the nitrogen vent pipe 55 and the first (No. 1) anti-sublimation evaporator 39 or the second (No. 2) anti-sublimation evaporator 40.

During de-icing, the pressure rises due to the sublimation of the CO₂ (or SO₂) in the anti-sublimation evaporators 39 and 40, which are now in a closed cycle. The pressure equals 5.2 bar at the equilibrium temperature of the triple point. The CO₂ (or SO₂) passes over from the solid state into the liquid state at this pressure.

The nitrogen flow M_{N2} in the nitrogen vent pipe 55 accounts for only 71.9% of the initial mass flow of the fumes. The pressure of nitrogen alone is equal to 0.736 bar, without taking into account the pressure drops or the trace gases.

The outlet pipe 2 of the internal combustion engine 1, the fume pipe 13 and the nitrogen vent pipe 55 communicate with one another, forming one cycle.

The removal of the water in the fume cooling heat exchanger 11 in the first (No. 1) fume cooling evaporator 25 and in the dehydrating unit 56 would lead to a reduction of the pressure in the pipes 2, 13, 55 if it were not compensated: The atmospheric air would enter the refrigerating device via the nitrogen vent pipe 55. The anti-sublimation of CO₂ (or SO₂) in the anti-sublimation evaporators 39 and 40 would also lead to a further pressure drop. This pressure drop must be compensated in order for the nitrogen to be able to be discharged into the atmosphere. The solution shown in FIG. 3 is a solution involving an air compressor 57 injecting an air flow via the pipe 58, the venturi injection pipe, at the neck of a venturi 59, permitting a nitrogen flow to be drawn in under a pressure on the order of magnitude of 0.65 bar and preventing the entry of air into the system. This solution is also of interest for recreating the nitrogen and oxygen mixture at the outlet of the venturi.

Another solution, not shown in FIG. 3, involves the arrangement of a compressor with a small pressure difference, of the blowing type, at the outlet of the fume cooling heat exchanger 11, in the fume pipe 13 to create the overpressure that permits the venting of the nitrogen or the nitrogen flow to which trace components are added into the atmosphere at the outlet of the nitrogen vent pipe 55.

If the contents of the trace components and particularly those of carbon monoxide CO and certain light-weight hydrocarbons are not negligible, the flows of nitrogen and the trace components can be returned into a mixer with an additional adequate air flow to create a so-called lean combustible mixture. The combustion of this combustible mixture is favorable for the reduction of the pollutants and for increasing the energy efficiency of a internal combustion engine designed for this purpose.

It is seen that during the de-icing of CO₂ (or SO₂) in the operating anti-sublimation evaporator, the temperature varies between −80° C. and −55° C. This considerable variation of the temperature can be utilized to regulate the alternation of the two anti-sublimation evaporators. In fact, when the temperature of −55° C. is reached during the de-icing of CO₂ (or SO₂), the CO₂ (or SO₂) can be considered to have passed completely over into the liquid phase. The liquid CO₂ (or liquid SO₂) suction pump can now be switched on for the transfer into the storage tank 49. It is now possible, by measuring the pressures in the interior volume of the CO₂ (or SO₂) de-icing evaporator, to stop the emptying process and then to restart the cycle, evaporating the refrigerant in this anti-sublimation evaporator, from which the liquid CO₂ (or liquid SO₂) was previously emptied. It is noted that at the beginning of the cycle, when no evaporator has ice in it, the compression system with integrated cascade consumes more energy. In fact, the mixture, which is expanding in the anti-sublimation evaporator, is not undercooled. The optimization of the energy parameters takes into account the most probable operating times of the engine, the energy production process, etc., to set the rhythm of the alternations between the two evaporators.

The present invention also pertains to a method and a system that make it possible to extract (capture) the CO₂ and/or SO₂ by anti-sublimation (ice formation) under atmospheric pressure or quasi-atmospheric pressure at + or −0.3 bar of CO₂ in methane (CH₄) extracted from gas fields. The capture of SO₂ alone also applies to gaseous effluents or fumes when this SO₂ has concentrations ranging from 0.1% to 3%. More particularly, it pertains to a method and to a system which make it possible to capture the gas-phase CO₂ and/or SO₂ contained in a methane gas flow, particularly in methane (CH₄) extracted from gas fields, by solidification.

This capture of CO₂ and/or SO₂ is carried out for the storage, reinjection, conversions or subsequent utilizations thereof.

The carbon dioxide or CO₂ emissions lead to an increase in the atmospheric CO₂ concentration, which is considered to be unacceptable in the long term. The Kyoto Protocol consists of commitments on the part of the member countries to limit these emissions. The capture of carbon dioxide and its sequestration are indispensable goals for the economic development and the maintenance of atmospheric concentrations at levels that limit the change in climate. The emissions of SOₓ (SO₂, SO₃ and other oxides) have already been regulated in order to prevent acid rain as well as to limit the respiratory accidents in urban areas. For various reasons, the capture of CO₂ and SO₂ represent existing or emerging markets for the pollution reduction systems.

The present invention pertains to a method for capturing carbon dioxide and minor species by anti-sublimation under low partial pressure. Methane (CH₄) liquefies under atmospheric pressure at −161.5° C., whereas CO₂ and SO₂ pass over from the gaseous phase into the solid phase under atmospheric pressure at temperatures ranging from −80° C. to −120° C. depending on their partial pressures in the gas mixture.

For example, SO₂ forms ice on the entire cold wall, whose temperature is typically below −75° C., at a volume concentration on the order of 0.5%. These compounds can then be recovered in the liquid phase by an alternating ice formation/de-icing process during which the pressure and the temperature rise above the respective triple points of CO₂ and SO₂ in a closed and sealed space during this de-icing. This alternating de-icing process can be advantageously designed such as to recover the energy released during de-icing.

The present invention pertains to a method of extracting CO₂ and/or SO₂. The method according to the present invention comprises the step of cooling the methane extracted from a borehole under a pressure approximately equal to the atmospheric pressure at such a temperature that the CO₂ and/or SO₂ pass directly over from the vapor state into the solid state via an anti-sublimation process.

The step comprising the cooling of the methane extracted from a borehole under a pressure approximately equal to the atmospheric pressure at such a temperature that the carbon dioxide CO₂ and/or SO₂ pass directly over from the vapor state into the solid state via an anti-sublimation process preferably comprises, moreover, the step of cooling the methane extracted from a borehole, on the one hand, and the CO₂, SO₂, on the other hand, by supplying frigories by means of the fractionated distillation of a mixture of refrigerant fluids. This fractionated distillation is carried out at decreasing temperature levels of the refrigerant fluid mixture according to a cycle comprising a phase of compression and successive phases of condensation and evaporation.

The step comprising the cooling of the methane extracted from a borehole under a pressure approximately equal to the atmospheric pressure at such a temperature that the CO₂ and/or the SO₂ pass directly over from the vapor state into the solid state via an anti-sublimation process is preferably followed by a step of melting of the CO₂ and/or the SO₂ in a closed space. The pressure and the temperature in the closed space change up to the triple points of the CO₂ and/or SO₂ as the mixture of refrigerant fluids, undergoing undercooling, supplies calories for the closed space.

The mixture of refrigerant fluids preferably successively ensures:
the melting of the CO₂ and/or SO₂ in the closed space, and
the sublimation of the CO₂ and/or SO₂ circulating in a closed cycle in a space symmetrical with the preceding one.

The melting and the anti-sublimation of the CO₂ and/or SO₂ are carried out alternately in one or the other of the spaces: one being closed while the other is open.

The method according to the present invention preferably also comprises the step of storing the CO₂ and/or SO₂ in the liquid form in a tank, especially a removable one.

The step of storing the CO₂ and/or SO₂ in the liquid form in the tank, especially a removable tank, comprises the following steps:
the step of drawing in the CO₂ and/or SO₂ in the liquid form, which are contained in the closed space,
the step of bringing the pressure in the closed space to a pressure close to the atmospheric pressure, and
the step of transferring the CO₂ and/or SO₂ in the liquid form into the tank.

The method according to the present invention preferably also comprises the step of cooling the methane extracted from a borehole to the anti-sublimation temperature of CO₂ and/or SO₂ under a pressure approximately equal to the atmospheric pressure, using the refrigerating energy available in the fumes without the additional supply of energy.

The system according to the present invention comprises cooling means for cooling the methane extracted from a borehole under a pressure approximately equal to the atmospheric pressure at such a temperature that the CO₂ and/or SO₂ passes directly over from the vapor state into the solid state via an anti-sublimation process.

The cooling means for cooling the methane extracted from a borehole under a pressure approximately equal to the atmospheric pressure at such a temperature that the CO₂ and/or SO₂ pass directly over from the vapor state into the solid state via an anti-sublimation process also comprise a refrigerating apparatus with an integrated cascade for cooling the methane flow and the CO₂ and/or the SO₂ by supplying frigories by means of the fractionated distillation of a mixture of refrigerant fluids. The fractionated distillation of the mixture of refrigerant fluids is carried out at decreasing temperature levels according to a cycle comprising a phase of compression and successive phases of condensation and evaporation. The refrigerating device comprises a compressor, a partial condenser, a separating tank, evaporating condensers, fume cooling evaporators, liquid-vapor heat exchangers, anti-sublimation evaporators, and expanders.

The system according to the present invention preferably also comprises a closed space traversed by a cycle in which a mixture of refrigerant fluids circulates. The pressure and the temperature in the closed space changes up to the triple points of CO₂ and/or SO₂ as
the mixture of the refrigerant fluids, while undercooling, supplies calories for the closed space, and
the CO₂ and/or SO₂ pass over from the solid state into the liquid state.

The mixture of refrigerant fluids preferably ensures successively the melting of CO₂ and/or SO₂ in the closed space and the anti-sublimation of the CO₂ and/or SO₂ circulating in an open cycle in a space symmetrical to the preceding one. The melting and the anti-sublimation of the CO₂ and/or SO₂ are carried out alternately in one or the other of the spaces, one being closed while the other is open.

The system according to the present invention preferably also comprises storage means, especially a stationary and/or removable tank for storing the CO₂ and/or the SO₂ in the liquid form.

The means for the storage of CO₂ and/or SO₂ in the liquid form in a stationary and/or removable tank preferably also comprise suction means, especially a pneumatic pump. The suction means make it possible to achieve a selectivity in the recovery of the SO₂ and CO₂ during their joint capture:
the SO₂ passes again over into the liquid state at a temperature of −75.5° C. and under a pressure of 0.016664 bar, and
the CO₂ passes again over into the liquid state at a temperature of −56.5° C. and a pressure of 5.2 bar.

The suction means also make it possible
to bring the pressure in the closed space to a pressure close to the atmospheric pressure, and
to transfer the liquid CO₂ and/or the liquid SO₂ into the tank.

The system according to the present invention preferably also comprises compression and/or suction means for transferring the methane extracted from a borehole into the devices corresponding to the storage or the subsequent treatments after the extraction of the CO₂ and/or SO₂ contained in the methane.

The system according to the present invention preferably also comprises transfer means for transferring the frigories contained in the methane after separation of the CO₂ and the SO₂ from the total flow (methane+CO₂+SO₂) entering the pipes of the refrigerating system and for thus contributing to the cooling of the total flow.

An embodiment variant of the present invention will now be described in a general manner. The gases to be treated are composed of:
on the one hand, methane (CH₄), whose typical concentration may range from 90% to 99%, and,
on the other hand, minor species: CO₂, whose volume concentration may range from 1% to 10%, and/or SO₂, whose concentration may range from 0.1% to 3%.

According to the method according to the present invention, the total flow comprising the methane extracted from a borehole and the CO₂ and/or SO₂ is cooled by a refrigerating cycle to a progressively lower temperature to permit the anti-sublimation of the CO₂ and/or SO₂ at a temperature that is between −80° C. and −120° C. and under a pressure that is on the order of magnitude of the atmospheric pressure + or −0.3 bar.

The term anti-sublimation designates here a direct gas/solid phase change that takes place when the temperature of the gas in question is below the triple point. FIG. 1 shows the schematic diagram showing the coexistence of the solid, liquid and vapor phases for all pure substances and particularly for SO₂. Below the triple point, the changes take place directly between the solid phase and the vapor phase. The changeover from the solid to the vapor is called sublimation. There is no term used commonly to designate the inverse change. The term anti-sublimation was used in this description to designate the direct change from the vapor phase to the solid phase.

Below the ambient temperature, the total flow is cooled in a cycle comprising a plurality of heat exchange segments. It is thus brought to a temperature below the anti-sublimation temperature of CO₂ and/or SO₂ under atmospheric pressure or close to the atmospheric pressure.

The cooling of the total flow is carried out in the different heat exchangers of the refrigerating system before arriving at the two anti-sublimation evaporators.

The two atmospheric pressure evaporators operate alternately. The total flow passes alternately over one or the other of the two evaporators.

During the phase of anti-sublimation, the CO₂ and/or SO₂ ice is deposited on the external walls of the heat exchanger cycle located in the anti-sublimation evaporator. This deposit progressively creates an obstacle to the circulation of the methane extracted from a borehole. After a certain operating time of this evaporator, the total flow as well as the flow of the mixture of refrigerant fluids are swung over to the symmetrical evaporator. The mixture of refrigerant fluids evaporates in this second evaporator in the interior of the heat exchanger and the CO₂ and/or SO₂ are deposited on the external surface thereof. The first evaporator is no longer the site of evaporation during this time, and the temperature consequently rises in this first evaporator. This temperature rise is accelerated by circulating the liquid refrigerant before expansion in the heat exchanger of the first evaporator. The SO₂ and/or CO₂, which are solid, are heated from temperatures that are between −80° C. and −120° C. to the respective melting points. The sublimation of the species that have formed an ice on the walls of the heat exchanger at first produces vapors, which cause the pressure to rise in the space of the evaporator in the course of the de-icing until the respective pressures corresponding to the triple points of the different substances (0.016 bar for SO_{2, 5.2} bar for CO₂) are reached. When these respective pressures are reached, the melting of the ice takes place from the solid phase to the liquid phase.

Once the SO₂, the minor species and the CO₂ are entirely in the liquid phase, they are transferred by relative depression into one or more heat-insulated tanks. Depending on the needs of separating SO₂ and CO₂ if they were iced up together, the transfers may be carried out at successive pressures corresponding to the preferential pressure of these compounds. At the end of the transfer, the pump is also able to draw in the residual gas or residual gases. It is thus possible to bring the pressure inside the space of the anti-sublimation evaporator from the final pressure corresponding to the end of the de-icing to the initial pressure, which is close to the atmospheric pressure, in order for the total flow to be able to re-enter it and for the CO₂ and/or the SO₂ to be able to be separated from the methane.

It is now possible to carry out the following cycle and to carry out the anti-sublimation of the CO₂ and/or SO₂ contained in the methane extracted from a borehole on the walls of the evaporator. The latter is again supplied with refrigerant fluid. The cycle continues, and so on, alternately in the two low-temperature evaporators connected in parallel.

The refrigerating device is based on a so-called integrated cascade cooling principle, which is known per se. The refrigerating device according to the present invention does, however, have specific technical features, which will be described below. In fact, to cool the fumes over a considerable temperature difference ranging from ambient temperature to −90° C. and even −120° C. by means of an easy-to-manufacture refrigerating device, the process according to the present invention uses a mixture of refrigerant fluids. The refrigerating device according to the present invention comprises a single compressor, two intermediate evaporating condensers and the two low-temperature anti-sublimation evaporators connected in parallel. The intermediate evaporating condensers make it possible at the same time to distill the mixture of refrigerant fluids and to progressively cool the flow of fumes.

The refrigerant fluid mixtures that make it possible to carry out a cycle may be ternary, quaternary or five-component mixtures. The mixtures described reflect the requirements of the Montreal Protocol, which bans the production and later the use of refrigerant gases containing chlorine. This implies that no CFC (chlorofluorocarbon) or H-CFC (hydrochlorofluorocarbon) is included among the suitable components, even though several of these fluids are quite interesting functionally for being used as working fluids in an integrated cascade. The Kyoto protocol also imposes requirements on the gases with a high global warming potential (GWP). Even if they are not banned currently, fluids with the lowest possible GWP are preferably used according to the present invention. The mixtures suitable for use in the integrated cascade according to the present invention to carry out the capture of the CO₂ present in the fumes are indicated below.
Ternary Mixtures

The ternary mixtures may be mixtures of methane/CO₂/R-152a or, according to the standardized nomenclature (ISO 817) of refrigerant fluids, mixtures of R-50/R-774/R-152a. It is possible to replace R-152a with butane R-600 or isobutane R-600a.
Quaternary Mixtures

The quaternary mixtures may be mixtures
of R-50/R-170/R-744/R-152a or
of R-50/R-170/R-744/R-600 or
of R-50/R-170/R-744/R-600a.
R-50 may also be replaced with R-14, but its GWP is very high (6,500 kg equivalents of CO₂).
Five-component Mixtures

The five-component mixtures can be prepared by selecting five of these compounds from the list of the following eight fluids: R-740, R-50, R-14, R-170, R-744, R-600, R-600a, R-152a in adequate proportions with progressively changing critical temperature levels, these critical temperatures being shown in Table 2. The following mixtures shall be mentioned as examples:
R-50/R-14/R-170/R-744/R-600 or
R-740/R-14/R-170/R-744/R-600 or
R-740/R-14/R-170/R-744/R-600a or
R-740/R-14/R-170/R-744/R-152a or
R-740/R-50/R-170/R-744/R-152a, R-740 being argon.

Table 2 shows the principal thermochemical characteristics and the names of these fluids.

TABLE 2

| Compound | | | | |
|---|---|---|---|---|
| Chemical and | | | | Molar |
| standardized name | Chemical | Critical T | Critical P | weight |
| (ISO 817) | formula | (° C.) | (bar) | (g/mole) |
| R-740 | A | −122.43 | 48.64 | 39.94 |
| Argon | | | | |
| R-50 | CH₄ | −82.4 | 46.4 | 16.04 |
| Methane | | | | |
| T-14 | CF₄ | −45.5 | 37.4 | 88.01 |
| Tetrafluoromethane | | | | |
| R-744 | CO₂ | 31.01 | 73.77 | 44.01 |
| Carbon dioxide | | | | |
| R-170: ethane | C₂H₆ | 32.2 | 48.9 | 30.06 |
| R-152a | CHF₂—CH₃ | 113.5 | 44.9 | 66.05 |
| Difluoroethane | | | | |
| R-600a | (CH₃)₃CH | 135 | 36.47 | 58.12 |
| Isobutane or 2- | | | | |
| methyl propane | | | | |
| R-600 | CH₄H₁₀ | 152 | 37.97 | 58.12 |
| n-Butane | | | | |

The two intermediate evaporating condensers and the anti-sublimation evaporators form the three temperature stages of the integrated cascade. These three stages operate all at the same pressure because they are all connected to the suction of the compressor, but the mean temperatures in these three stages are typically on the order of magnitude of −5° C., −30° C. and −90° C. because there must be a temperature difference between the flow of refrigerants circulating in the other pipe of each of the heat exchangers. For a system operating down to −120° C., the cascade may comprise four stages at the respective mean temperatures on the order of −5° C., −40° C., −85° C. and −120° C.

The flows of the refrigerant fluid mixtures in the three or four stages of the integrated cascade depend on the proportions of the components in the refrigerant fluid mixtures. Consequently, there is a link between the composition and the temperature levels of the cascade.

The data below, provided as an example, are related to a refrigerating device with integrated cascade using a five-component refrigerant fluid mixture, whose weight composition is as follows:

| | |
|---|---|
| R-50 | 1% |
| R-14 | 3% |
| R-170 | 19% |
| R-744 | 27% |
| R-600 | 50%. |

The proportion of the flammable and nonflammable components is such that the mixture is a nonflammable, safe mixture. The critical temperature of this mixture is 74.2° C. and its critical pressure is 50 bar.

The proportions of the components with the highest critical temperatures, here R-600 and R-744, are the highest in the mixture because their evaporation in the two intermediate stages makes it possible to carry out the distillation of the components with low critical temperature. The components with low critical temperatures can thus evaporate at low temperature in the anti-sublimation evaporator, which is a double evaporator operating alternately with one or the other of its parallel pipes.

The heat exchangers in the cascade are preferably counterflow heat exchangers. They make it possible to use great temperature differences between the inlets and the outlets. They also make possible the recovery of heat between the liquid phase and vapor at different temperatures.

If the methane is subsequently liquefied, the cooling continues according to the usual methane liquefaction process. By contrast, if it is not liquefied, the “cold” of the methane leaving the CO₂ and/or SO₂ anti-sublimation evaporator can be utilized to cool the total flow. The cold methane flow leaving the anti-sublimation evaporator participates in the cooling of the total flow until the temperature of the methane rises to the ambient temperature level. The pressure of the methane is now equal to values between 90% and 99% of the initial pressure of the total flow, taking into account the capture of the CO₂ and/or SO₂. The overpressure necessary for the circulation is generated, for example, by an air-cooled compressor, whose flow, injected into a venturi, permits the methane flow to be extracted after the extraction of the CO₂ and/or the SO₂.

Another concept is to compress the total flow upstream of the refrigerating system in such a way as to generate a slight overpressure compared to the atmospheric pressure along the cycle of the methane extracted from a borehole.

An embodiment variant of a plant intended for the concomitant extraction of CO₂ and SO₂ from fumes, especially those circulating in the smokestacks of electric power plants, was described above in detail. Subject to technical extrapolations which can be made by a person skilled in the art, this description is applicable to a plant intended for the extraction of the CO₂ and/or SO₂ contained in methane (CH₄) originating from gas fields.

NOMENCLATURE

| Nominal Group | References |
|---|---|
| Internal combustion engine | 1 |
| Internal combustion engine outlet pipe | 2 |
| Internal combustion engine cooling cycle | 3 |
| Energy recovery cycle of engine | 4 |
| Thermal energy recovery heat | 5 |
| exchanger of engine | |
| First fume cooling heat exchanger | 6 |
| Turbine | 7 |
| Air-cooled condenser | 8 |
| Pump | 9 |
| Alternator | 10 |
| Fume cooling heat exchanger | 11 |
| Cooling cycle | 12 |
| Fume outlet pipe of heat exchanger 11 | 13 |
| Condensate drainage pipe | 14 |
| Water drainage pipe of first (No. 1) | 15 |
| fume cooling evaporator | |
| Water collecting tank | 16 |
| Refrigerant compressor | 17 |
| Partial condenser | 18 |
| Cooling cycle of refrigerant condenser | 19 |
| Pipe | 20 |
| Pipe | 21 |
| Evaporating condenser No. 1 | 22 |
| Pipe | 23 |
| Expander | 24 |
| First (No. 1) fume cooling evaporator | 25 |
| Liquid-vapor heat exchanger No. 1 | 26 |
| Pipe | 27 |
| Separating tank | 28 |
| Gas outlet pipe | 29 |
| Pipe | 30 |
| Expander | 31 |
| Evaporating condenser No. 2 | 32 |
| Fume cooling evaporator No. 2 | 33 |
| Liquid-vapor heat exchanger No. 2 | 34 |
| Pipe | 36 |
| Three-way valve | 37 |
| Pipe | 38 |
| Anti-sublimation evaporators No. 1 | 39 |
| Anti-sublimation evaporators No. 2 | 40 |
| Expander No. 1 | 41 |
| Expander No. 2 | 42 |
| Pipe | 43 |
| Pipe | 44 |
| Gas return pipe | 45 |
| Three-way valve | 46 |
| Three-way valve | 47 |
| Pump | 48 |
| Storage tank | 49 |
| Pump | 50 |
| Removable tank | 51 |
| Valve | 52 |
| Three-way valve | 53 |
| Three-way valve | 54 |
| Nitrogen vent pipe | 55 |
| Dehydrating unit | 56 |
| Air compressor | 57 |
| Pipe | 58 |
| Venturi | 59 |

1.-48. (canceled)

49. Method of extracting sulfur dioxide or carbon dioxide and sulfur dioxide from fumes originating from the combustion of hydrocarbons in the presence of atmospheric oxygen and atmospheric nitrogen, comprising
the step of cooling the fumes under a pressure that ensures circulation of the fumes at such a temperature that the sulfur dioxide or the carbon dioxide and the sulfur dioxide pass directly over from the vapor state into the solid state via an anti-sublimation process, the step of cooling the fumes comprising:
the step of cooling the mixture of nitrogen, sulfur dioxide or carbon dioxide and sulfur dioxide by supplying frigories by means of fractionated distillation, at decreasing temperature levels, of a mixture of refrigerant fluids according to a cycle comprising a phase of compression and successive phases of condensation and evaporation.

50. Method in accordance with claim 49, wherein the step of cooling the fumes under the pressure that ensures circulation of the fumes at such a temperature that the sulfur dioxide or the carbon dioxide and the sulfur dioxide pass directly over from the vapor state into the solid state via an anti-sublimation process further comprises
the step of extracting liquid water from the fumes the liquid water being under a pressure approximately equal to the atmospheric pressure.

51. Method in accordance with claim 50, wherein an air or water heat exchanger is used to extract all or part of the liquid water from the fumes under the pressure approximately equal to atmospheric pressure.

52. Method in accordance with claim 51, wherein the method further comprises
the step of extracting all the residual quantities of water from the fumes by using at least one of a refrigerating heat exchanger or a dehydrating unit.

53. Method in accordance with claim 49, wherein the step comprising the cooling of the fumes under the pressure ensuring circulation of the fumes at such a temperature that the sulfur dioxide or the carbon dioxide and the sulfur dioxide pass directly over from the vapor state into the solid state via an anti-sublimation process is followed by
a step of melting the sulfur dioxide or the carbon dioxide and the sulfur dioxide in a closed space, the pressure and the temperature in the closed space during the melting changing to the triple point of the sulfur dioxide or the carbon dioxide and the sulfur dioxide as the mixture of refrigerant fluids, while undercooling, supplies calories for the closed space.

54. Method in accordance with claim 53, wherein the mixture of refrigerant fluids successively ensures the melting of the sulfur dioxide or the carbon dioxide and the sulfur dioxide in the closed space and the anti-sublimation of the sulfur dioxide or the carbon dioxide and the sulfur dioxide circulating in an open cycle in a space symmetrical to the closed space, the melting and the anti-sublimation of the sulfur dioxide or the carbon dioxide and the sulfur dioxide being carried out alternately in one or the other of the spaces, one being closed while the other is open.

55. Method in accordance with claim 54, wherein the method further comprises the step of storing the sulfur dioxide or the carbon dioxide and the sulfur dioxide in the liquid form in a tank.

56. Method in accordance with claim 55, wherein the step of storing the sulfur dioxide or the carbon dioxide and the sulfur dioxide in the liquid form in a tank, comprises the following steps:
the step of drawing in the liquid sulfur dioxide or the liquid carbon dioxide and the liquid sulfur dioxide contained in the closed space,
the step of bringing the pressure in the closed space to a pressure close to the atmospheric pressure, and
the step of transferring the liquid sulfur dioxide or the liquid carbon dioxide and the liquid sulfur dioxide into the tank.

57. Method in accordance with claim 49, wherein the method further comprises the step of discharging the nitrogen into the outside air after successive extractions of the steam, the sulfur dioxide or the carbon dioxide and the sulfur dioxide contained in the fumes.

58. Method in accordance with claim 57, wherein the method further comprises the step of transferring the frigories contained in the nitrogen discharged into the outside air to the fumes and of thus contributing to the cooling of the fumes.

59. Method in accordance with claim 49, wherein the method further comprises the step of cooling the fumes to the anti-sublimation temperature of the sulfur dioxide or the carbon dioxide and the sulfur dioxide under a pressure ensuring circulating of the fumes, utilizing the heat energy available in the fumes without the additional supply of energy.

60. Method in accordance with claim 59, wherein, to utilize the heat energy available in the fumes, the method further comprises the following steps:
the step of heating and then evaporating water by means of the fumes to generate steam under pressure, and
the step of expanding the steam under pressure in a turbine to generate mechanical energy or electricity.

61. System of extracting the sulfur dioxide or the carbon dioxide and the sulfur dioxide from fumes originating from the combustion of hydrocarbons in the presence of atmospheric oxygen and atmospheric nitrogen comprising:
cooling means for cooling the fumes under a pressure ensuring circulation of the fumes at such a temperature that the sulfur dioxide or the carbon dioxide and the sulfur dioxide pass directly over from the vapor state into the solid state via an anti-sublimation process, the cooling means comprising:
a refrigerating device with integrated cascades for cooling the mixture of nitrogen, sulfur dioxide or carbon dioxide and sulfur dioxide by supplying frigories by means of fractionated distillation, at decreasing temperature levels, of a mixture of refrigerant fluids according to a cycle comprising a phase, of compression and successive phases of condensation and evaporation;
the refrigerating device comprising:
a compressor,
a partial condenser,
a separating tank,
multiple evaporating condensers,
multiple fume cooling evaporators,
multiple anti-sublimation evaporators, and
multiple expanders.

62. System in accordance with claim 61, wherein the means for cooling the fumes under the pressure ensuring the circulation of the fumes at such a temperature that the sulfur dioxide or the carbon dioxide and the sulfur dioxide pass directly over from the vapor state into the solid state via an anti-sublimation process also comprises
extraction means, for extracting from the fumes water in the liquid form under a pressure approximately equal to the atmospheric pressure.

63. System in accordance with claim 62, wherein the extraction means for extracting from the fumes all or part of the water in the liquid form under a pressure approximately equal to the atmospheric pressure comprise an air or water heat exchanger.

64. System in accordance with claim 63, wherein the extraction means for extracting the water present in the fumes comprises at least one of a cooling heat exchanger or a dehydrating unit.

65. System in accordance with claim 61, wherein the system further comprises
a closed space traversed by a cycle in which circulates a mixture of refrigerant fluids;
the pressure and the temperature in the closed space changing to the triple point of the sulfur dioxide or the carbon dioxide and the sulfur dioxide as the mixture of refrigerant fluids, while undercooling, supplies calories for the space, and the sulfur dioxide or the carbon dioxide and the sulfur dioxide pass over from the solid state into the liquid state.

66. System in accordance with claim 65, wherein the mixture of refrigerant fluids successively ensures the melting of the sulfur dioxide or the carbon dioxide and the sulfur dioxide in a closed space and the anti-sublimation of the sulfur dioxide or the carbon dioxide and the sulfur dioxide circulating in an open cycle in an open space symmetrical to the closed space; the melting and the anti-sublimation of the sulfur dioxide or the carbon dioxide and the sulfur dioxide being carried out alternately in one or the other of the spaces, one being closed while the other is open.

67. System in accordance with claim 66, wherein the system further comprises storage means for storing the sulfur dioxide or the carbon dioxide and the sulfur dioxide in the liquid form.

68. System in accordance with claim 67, wherein the means for storing the sulfur dioxide or the carbon dioxide and the sulfur dioxide in the liquid form also comprises suction means for:
drawing in the liquid sulfur dioxide or the liquid carbon dioxide and the liquid sulfur dioxide contained in the space,
for bringing the pressure in the space to a pressure close to the atmospheric pressure, and
for transferring the liquid sulfur dioxide or the liquid carbon dioxide and the liquid sulfur dioxide into the tank.

69. System in accordance with claim 61, wherein the system further comprises
at least one of compression means or suction means for discharging the nitrogen into the outside air after the successive extractions of the steam, sulfur dioxide or carbon dioxide and sulfur dioxide contained in the fumes.

70. System in accordance with claim 69, wherein the system also comprises
transfer means for transferring the frigories contained in the nitrogen discharged into the outside air to the fumes and for thus contributing to the cooling the fumes.

71. System in accordance with claim 61, wherein the system further comprises
means for recovering heat energy available in the fumes for cooling, at least partially, the fumes to the anti-sublimation temperature of the sulfur dioxide or the carbon dioxide and the sulfur dioxide under a pressure ensuring circulation of the fumes.

72. System in accordance with claim 71, wherein the means for recovering the heat energy available in the fumes comprise:
heating means for heating and evaporating the water by means of the fumes and for generating steam under pressure, and
expansion means, for expanding the steam under pressure and generating mechanical energy or electricity.

73. Method of extracting at least one of carbon dioxide or sulfur dioxide contained in methane originating especially from gas fields,
the method comprising the following steps:
the step of cooling the methane under a pressure ensuring circulation of the methane at such a temperature that at least one of the carbon dioxide or the sulfur dioxide pass directly over from the vapor state into the solid state via an anti-sublimation process, the step comprising the cooling of the methane comprising
the step of cooling the mixture of methane, and the at least one of carbon dioxide or sulfur dioxide by supplying frigories by means of fractionated distillation, at decreasing temperature levels, of a mixture of refrigerant fluids according to a cycle comprising a phase of compression and successive phases of condensation and evaporation.

74. Method in accordance with claim 73, wherein the methane contains water in the vapor state and the method is such that the step of cooling the methane under the pressure ensuring circulation of the methane at such a temperature that at least one of the carbon dioxide or the sulfur dioxide pass directly over from the vapor state into the solid state via an anti-sublimation process also comprises
the step of extracting the water in liquid form from the methane under a pressure approximately equal to atmospheric pressure.

75. Process in accordance with claim 74, wherein an air or water heat exchanger is used to extract all or part of the water in the liquid form from the methane under a pressure approximately equal to atmospheric pressure.

76. Method in accordance with claim 75, wherein the method further comprises
the step of extracting all residual quantities of water present in the methane by using at least one of a refrigerating heat exchanger or a dehydrating unit.

77. Method in accordance with claim 73, wherein the step comprising the cooling of the methane under the pressure ensuring circulation of the methane at such a temperature that at least one of the carbon dioxide or the sulfur dioxide pass directly over from the vapor state into the solid state via an anti-sublimation process is followed by
a step of melting of at least one of the carbon dioxide or the sulfur dioxide in a closed space, the pressure and the temperature in the closed space during the melting changing to the triple point of the at least one of the carbon dioxide or the sulfur dioxide as the mixture of refrigerant fluids, while undercooling, supplies calories for the space.

78. Method in accordance with claim 77, wherein the mixture of refrigerant fluids ensures successively the melting of the at least one of the carbon dioxide or the sulfur dioxide in a closed space and the anti-sublimation of the at least one of the carbon dioxide or the sulfur dioxide circulating in an open cycle in an open space symmetrical to the closed space, the melting and the anti-sublimation of the at least one of the carbon dioxide or the sulfur dioxide being carried out alternately in one or the other of the spaces, one being closed while the other is open.

79. Method in accordance with claim 78, wherein the method further comprises
the step of storing the at least one of the carbon dioxide or the sulfur dioxide in liquid form in a tank.

80. Method in accordance with claim 79, wherein the step of storing the at least one of the carbon dioxide or the sulfur dioxide in the liquid form in the tank, comprises the following steps:
the step of drawing in the at least one of the liquid carbon dioxide or the liquid sulfur dioxide contained in the closed space,
the step of bringing the pressure in the closed space to a pressure ensuring circulation of the methane, and
the step of transferring the at least one of the liquid carbon dioxide or the liquid sulfur dioxide into the tank.

81. Method in accordance with claim 73, wherein the method further comprises
the step of recovering the methane after the extractions of the at least one of the carbon dioxide or the sulfur dioxide contained in the methane.

82. Method in accordance with claim 81, wherein the method further comprises
the step of transferring the frigories contained in the recovered methane into the methane originating from a gas field and of thus contributing to the cooling of the methane.

83. Method in accordance with claim 73, wherein the methane is at a temperature higher than the ambient temperature, and that the method further comprises
the step of cooling the methane to the anti-sublimation temperature of the at least one of the carbon dioxide or the sulfur dioxide under a pressure ensuring circulation of the methane by utilizing the heat energy available in the methane without the additional supply of energy.

84. Method in accordance with claim 83, wherein, to utilize the heat energy available in the methane, the method further comprises the following steps:
the step of heating and then evaporating the water by means of the methane for generating steam under pressure, and
the step of expanding the steam under pressure in a turbine, generating mechanical energy or electricity.

85. System for extracting at least one of carbon dioxide or sulfur dioxide contained in the methane originating especially from gas fields, comprising:
cooling means for cooling the methane under a pressure ensuring circulation of the methane at such a temperature that the at least one of the carbon dioxide or the sulfur dioxide pass directly over from the vapor state into the solid state via an anti-sublimation process, the cooling means comprising:
a refrigerating device with an integrated cascade for cooling the mixture of methane, and at least one of carbon dioxide or sulfur dioxide by supplying frigories by means of fractionated distillation, at decreasing temperature levels, of a mixture of refrigerant fluids according to a cycle comprising a phase of compression and successive phases of condensation and evaporation;
the refrigerating device comprising:
a compressor,
a partial condenser,
a separating tank,
multiple evaporating condensers,
multiple fume cooling evaporators,
multiple liquid-vapor heat exchangers,
multiple anti-sublimation evaporators, and
multiple expanders.

86. System in accordance with claim 85, wherein the methane contains water in the vapor state, and that the means for cooling the methane under the pressure ensuring circulation of the methane at such a temperature that the at least one of the carbon dioxide or the sulfur dioxide pass directly over from the vapor state into the solid state via an anti-sublimation process also comprise
extraction means, for extracting from the methane the water in the liquid form under a pressure approximately equal to the atmospheric pressure.

87. System in accordance with claim 86, wherein the extraction means for extracting from the methane all or part of the water in the liquid form under a pressure approximately equal to the atmospheric pressure comprises an air or water heat exchanger.

88. System in accordance with claim 87, wherein the extraction means for extracting the water present in the methane comprises at least one of a refrigerating heat exchanger or a dehydrating unit.

89. System in accordance with claim 85, wherein the system further comprises:
a closed space traversed by a cycle in which circulates a mixture of refrigerant fluids such that
the pressure and the temperature in the closed space changing to the triple point of the at least one of the carbon dioxide or the sulfur dioxide as the mixture of refrigerant fluids, while undercooling, supplies calories for the space, and the at least one of the carbon dioxide or the sulfur dioxide pass over from the solid state into the liquid state.

90. System in accordance with claim 89, wherein the mixture of refrigerant fluids successively ensures the melting of the at least one of the carbon dioxide or the sulfur dioxide in a closed space and the anti-sublimation of the at least one of the carbon dioxide or the sulfur dioxide circulating in an open cycle in a space symmetrical to the closed space; the melting and the anti-sublimation of the at least one of the carbon dioxide or the sulfur dioxide being carried out alternately in one or the other of the spaces, one being closed while the other is open.

91. System in accordance with claim 85, further comprising
storing means, for storing the at least one of the carbon dioxide or the sulfur dioxide in the liquid form.

92. System in accordance with claim 91, wherein the means of storing the at least one of the carbon dioxide or the sulfur dioxide in the liquid form also comprise suction means, for drawing in the at least one of the liquid carbon dioxide or the liquid sulfur dioxide contained in the space, bringing the pressure in the space to a pressure ensuring circulation of the methane, and transferring the at least one of the liquid carbon dioxide or the liquid sulfur dioxide into the tank.

93. System in accordance with claim 85, wherein the system further comprises
at least one of means of compression or means of suction for recovering the methane after the extraction of the at least one of the carbon dioxide or the sulfur dioxide contained in the methane.

94. System in accordance with claim 93, wherein the system further comprises
transfer means for transferring the frigories contained in the recovered methane to the methane originating from the gas field and thus contributing to the cooling of the methane.

95. System in accordance with claim 85, wherein the methane is at a temperature higher than the ambient temperature, and that the system further comprises
means of recovering the heat energy available in the methane for cooling, at least partially, the methane to the anti-sublimation temperature of the at least one of the carbon dioxide or the sulfur dioxide under a pressure ensuring circulation of the methane.

96. System in accordance with claim 95, wherein the means of recovering the heat energy available in the methane comprises:
heating means, for heating and evaporating water by means of the fumes and for generating steam under pressure, and
expansion means, especially a turbine, for expanding the steam under pressure and generating mechanical energy or electricity.
